(19) United States
(12) Patent Application Publication
(10) Pub. No.: US 2026/0057723 A1
(43) Pub. Date: Feb. 26, 2026

(54) Methods and Systems for Shareholder Election

(71) Applicant: The PNC Financial Services Group, Inc., Pittsburgh, PA (US)

(72) Inventors: Susan Haise, Minneapolis, MN (US); Jamie Roseberg, Andover, MN (US); Jordyn Stadler, Parker, CO (US); Lioudmila Semenova, Pasadena, CA (US)

(73) Assignee: The PNC Financial Services Group, Inc., Pittsburgh, PA (US)

(21) Appl. No.: 19/376,159

(22) Filed: Oct. 31, 2025

Related U.S. Application Data
(63) Continuation of application No. 18/973,859, filed on Dec. 9, 2024.
(60) Provisional application No. 63/562,608, filed on Mar. 7, 2024.

(51) Int. Cl. G07C 13/00

(52) U.S. Cl. CPC G07C 13/00; G06Q 2230/00

(57) ABSTRACT

The present disclosure is generally related to systems and methods for executing events associated with an asset, which involve election of a multiplier of the asset by an owner of the asset. The present disclosure provides systems and methods for presenting an event associated with an asset to an owner of the asset, setting up a system for executing an event associated with an asset, and presenting an election result in an event associated with an asset, respectively.

### CROSS-REFERENCE TO RELATED APPLICATIONS

The present application claims priority to Provisional U.S. Patent Application Ser. No. 63/562,608, filed Mar. 7, 2024, the disclosure of which is incorporated herein by reference.

### FIELD OF DISCLOSURE

The present disclosure is generally related to systems and methods for executing events associated with an asset. In particular, the disclosed systems and methods may involve election of a multiplier of the asset by an owner of the asset.

### BACKGROUND

Shareholder tender election plays a critical role in major corporate events, such as mergers, acquisitions, and restructurings. It enables shareholders to make key decisions in response to tender offers, exchange offers, or other corporate actions that directly affect their investment interests. However, conventional methods and systems for shareholder tender election often lack efficiency in facilitating election operations and fall short in providing clear, intuitive representations of election progress and results.

For example, existing systems for shareholder elections are frequently not user-friendly and offer limited customization options for election settings. This can lead to frustration and confusion among shareholders because they are unable to easily navigate the system to make their desired elections. Additionally, the lack of flexibility in these systems presents significant limitations for companies with unique shareholder election requirements. A more customizable system can better support companies in managing their shareholder elections, allowing them to tailor the process to their specific needs.

Furthermore, current systems typically present shareholder tender election results in textual or tabular formats, which can be cumbersome to interpret and ineffective in conveying complex patterns or trends. These conventional methods make it challenging for shareholders, corporate executives, and other stakeholders to monitor election progress, fully understand the outcomes, and make informed decisions based on the results. The increased emphasis on transparency, accountability, and shareholder engagement in corporate governance highlights the need for innovative solutions that improve accessibility to shareholder tender election results.

To address these limitations, there is a need for a more user-friendly and customizable system that can accommodate the needs of both shareholders and companies. A more efficient and flexible system ensures that the shareholder elections are conducted efficiently and effectively, which provides a positive experience for both the shareholders and the companies. There is also a need for methods and systems that present shareholder election results in a clear, intuitive, and informative manner.

### SUMMARY

The systems and methods for shareholder election described in this disclosure provide significant improvement over traditional systems and methods for shareholder election. The system is designed to provide greater flexibility in election settings, providing shareholders with a more streamlined user experience, and presenting the election status and results to the companies in a real-time and visualized manner.

A system may be configured to perform particular operations or actions by virtue of having software, firmware, hardware, or a combination of them installed on the system that in operation cause the system to perform the actions. One or more computer programs can be configured to perform particular operations or actions by virtue of including instructions that, when executed by data processing apparatus, cause the apparatus to perform the actions.

In an aspect, the present disclosure discloses an electronic system comprising a memory storing instructions; a database, in electronic communication with the memory, configured to store information including: information of a user, including a first attribute associated with an eligibility of the user, a second attribute associated with a multiplier of an asset, and a third attribute associated with an ownership of the asset; information about an event associated with the asset; and at least one processor configured to execute the instructions to perform operations including: determining the user's eligibility to view a first dashboard configuration according to the first attribute; responsive to a determination that the user is eligible: providing for display on the user's user interface the first dashboard configuration including the information about the event; providing for display on the user's user interface a second dashboard configuration including at least one prompt associated with the multiplier of the asset, wherein the user may be required to elect a quantity of the asset to participate in the event; providing for display on the user's user interface a third dashboard configuration including at least one prompt associated with a transfer of the ownership of the asset at the quantity elected by the user, wherein the user may be required to provide a method for receiving consideration for the asset; providing for display on the user's user interface a fourth dashboard configuration including a document for the user to sign, wherein the document includes the quantity of the asset elected by the user; and storing to the database: the quantity of the asset elected by the user; the method for receiving consideration provided by the user; and the document signed by the user.

In some embodiments, the operations may further include: prior to determining the user's eligibility to view the first dashboard configuration, providing for display on the user's user interface a fifth dashboard configuration including at least one inquiry associated with the eligibility and one or more selectable options for each inquiry, and storing a selection associated with the at least one inquiry in the database, wherein the user's eligibility to view the first dashboard configuration may be determined according to the first attribute and the user's selection to the at least one inquiry.

In some embodiments, the operations may further include: prior to providing for display the second dashboard configuration, providing for display on the user's user interface a sixth dashboard configuration including at least one inquiry associated with event participation, and one or more selectable options for each inquiry, storing a selection associated with the at least one inquiry in the database, wherein the second dashboard configuration is displayed on the user's user interface only if the user selects to participate in the event.

In some embodiments, the quantity of the asset that the user can elect may be subject to a predetermined upper limit.

In some embodiments, the at least one processor may be configured to perform the operations on or before a predetermined date.

In some embodiments, the first attribute is associated with a number of the asset owned by the user.

In some embodiments, the quantity of the asset is in the form of a number or a percentage.

In an aspect, the present disclosure discloses a method including determining a user's eligibility to view a first dashboard configuration according to a first attribute associated with an eligibility of the user; responsive to a determination that the user is eligible: providing for display on the user's user interface the first dashboard configuration including the information about an event associated with an asset; providing for display on the user's user interface a second dashboard configuration including at least one prompt associated with a multiplier of the asset, wherein the user may be required to elect a quantity of the asset to participate in the event; providing for display on the user's user interface a third dashboard configuration including at least one prompt associated with a transfer of the ownership of the asset at the quantity elected by the user, wherein the user may be required to provide a method for receiving consideration for the asset; providing for display on the user's user interface a fourth dashboard configuration including a document for the user to sign, wherein the document includes the quantity of the asset elected by the user; and storing to the database: the quantity of the asset elected by the user; the method for receiving consideration provided by the user; and the document signed by the user.

In an aspect, the present disclosure discloses an electronic system including a memory storing instructions; a database, in electronic communication with the memory, configured to store information including: information of an asset, including a first attribute associated with a multiplier of the asset, and a second attribute associated with an ownership of the asset; at least one processor configured to execute the instructions to perform operations including: providing for display on a user interface a first dashboard configuration prompting a user to provide information about an event associated with the asset, wherein the event involves election of a multiplier of the asset by an owner of the asset; providing for display on the user interface a second dashboard configuration including one or more settings associated with at least one inquiry to be presented to the owner, wherein the one or more settings may be selected from an inquiry content, a plurality of selectable response options, and one or more selectable order options; providing for display on the user interface a third dashboard configuration including one or more election setting associated with the election by the owner of the asset, wherein the one or more election setting may be selected from options for an expiration date, options for a data type of the owner's input in the election, options for an increment of the owner's input in the election, and options for a range of the owner's input in the election, wherein the user's input may be either an integer or a percentage; and storing to the database: the information about the event; the one or more settings associated with at least one inquiry; and the one or more election setting.

In some embodiments, the one or more settings further includes selectable actions to be triggered by each selectable option for the at least one inquiry.

In some embodiments, the operations may further include: providing for display on the user interface a fourth dashboard configuration including one or more confirmation setting associated with a confirmation of a transfer of asset at the multiplier elected by the user, wherein the one or more confirmation setting may be selected from a content of at least one inquiry about an owner's preferred method for receiving consideration for the asset, and a content of a document associated with the election to be signed by the owner, and storing the one or more confirmation setting to the database.

In some embodiments, the operations may further include: providing for display, on the user interface, a fifth dashboard configuration including one or more presentation setting associated with a presentation of the event to the owner, wherein the one or more presentation setting includes selectable options for an order of each of the at least one question, the election, and the confirmation of a transfer.

In an aspect, the present disclosure discloses a method comprising providing for display on a user interface a first dashboard configuration prompting a user to provide information about an event associated with an asset, wherein the event involves election of a multiplier of the asset by an owner of the asset; providing for display on the user interface a second dashboard configuration including one or more settings associated with at least one inquiry to be presented to an owner of the asset, wherein the one or more settings may be selected from an inquiry content, a plurality of selectable response options, and one or more selectable order options; providing for display on the user interface a third dashboard configuration including one or more election setting associated with the election by the owner of the asset, wherein the one or more election setting may be selected from options for an expiration date, options for a data type of the owner's input in the election, options for an increment of the owner's input in the election, and options for a range of the owner's input in the election, wherein the user's input may be either an integer or a percentage; and storing to the database: the information about the event; the one or more settings associated with at least one inquiry; and the one or more election setting.

In an aspect, the present disclosure discloses an electronic system including a memory storing instructions; a database, in electronic communication with the memory, configured to store information including: an information of a user including a first attribute associated with an eligibility, an information about an asset, including information of each owner of the asset, a multiplier of the asset owned by each owner of the asset, a total number of owners of the asset, and a total multiplier of the asset, an information about an event associated with the asset, wherein the event involves election of a multiplier of the asset by the owner of the asset, wherein the information about the event includes a maximum total multiplier of the asset that can be elected by the owner of the asset, an election result for each of the owners of the asset, including the multiplier of the asset elected by each of the owners of the asset, and a summary of election results, including a number of owners who participate in the event, and a total multiplier of the asset elected by the owner of the asset; at least one processor configured to execute the instructions to perform operations including determining the user's eligibility to view the election result according to the first attribute, retrieving from the database the summary of the election result, and, responsive to determining that the user is eligible, providing for display on a user interface a first dashboard configuration including at least one graphical element illustrating the summary of election results.

In some embodiments, the operations further include retrieving from the database the total number of owners of the asset and displaying in the first dashboard configuration a graphical element illustrating a first percentage of the owners who participate in the event over the total number of owners of the asset.

In some embodiments, the operations may further include retrieving from the database the total multiplier of the asset and displaying in the first dashboard configuration a graphical element illustrating a second percentage of the total multiplier of the asset elected by the owner of the asset over the total multiplier of the asset.

In some embodiments, the operations may further include retrieving from the database the maximum total multiplier of the asset that can be elected by the at least one owner of the asset and displaying in the first dashboard configuration a graphical element illustrating a third percentage of the total multiplier of the asset elected by the at least one owner of the asset over the maximum total multiplier of the asset that can be elected by the at least one owner of the asset.

In some embodiments, the operations may further include instructions to repeat all the operations at a predetermined time interval.

In some embodiments, the operations may further include instructions to repeat all the operations upon the user's request.

In some embodiments, the first dashboard configuration may be configured to allow the user to turn on or off the at least one graphical element.

In some embodiments, the at least one graphical element displayed in the first dashboard configuration may be a progress bar, a pie chart, or a table.

In some embodiments, the first dashboard configuration may further include a report document including the summary of the election results.

In some embodiments, the operations further include retrieving the election result for each of the owners of the asset, wherein the first dashboard configuration further includes a report document including the election result for each of the owners of the asset.

In an aspect, the present disclosure discloses a method including determining a user's eligibility to view an election result associated with an event, according to a first attribute, wherein the event may be associated with an asset and involves an election of a multiplier of the asset by an owner of the asset, retrieving from a database a summary of the election result, including a number of owners who participate in the event, and a total multiplier of the asset elected by the owner of the asset, and, responsive to determining that the user is eligible, providing for display on a user interface a first dashboard configuration including at least one graphical element illustrating the summary of the election results.

In some embodiments, the operations may further include retrieving from the database a total number of owners of the asset and displaying in the first dashboard configuration a graphical element illustrating a first percentage of the owners who participate in the event over the total number of owners of the asset.

In some embodiments, the operations may further include retrieving from the database a total multiplier of the asset owned by an owner and displaying in the first dashboard configuration a graphical element illustrating a second percentage of the total multipliers of the asset elected by the owner of the asset over the total multiplier of the asset owned by the owner.

In some embodiments, the operations may further include retrieving from the database the maximum total multiplier of the asset that can be elected by the at least one owner of the asset and displaying in the first dashboard configuration a graphical element illustrating a third percentage of the total multiplier of the asset elected by the at least one owner of the asset over the maximum total multiplier of the asset that can be elected by the at least one owner of the asset.

In some embodiments, the operations may be repeated at a predetermined time interval.

In some embodiments, the operations may be repeated upon the user's request.

In some embodiments, the first dashboard configuration may be configured to allow the user to turn on or off the at least one graphical element.

In some embodiments, the at least one graphical element displayed in the first dashboard configuration may be a progress bar, a pie chart, or a table.

In some embodiments, the first dashboard configuration may further include a report document including the summary of the election results.

In some embodiments, the operations may further include retrieving an election result for each of the owners of the asset, wherein the first dashboard configuration further includes a report document including the election result for each of the owners of the asset.

### BRIEF DESCRIPTION OF FIGURES

The accompanying drawings, which are incorporated in and constitute a part of this specification, illustrate disclosed embodiments and, together with the description, serve to explain the disclosed embodiments.

FIG. 1A is a schematic illustration of a traditional process of shareholder election in a tender offer.

FIG. 1B is a schematic illustration of the systems and portals for executing a shareholder election, consistent with disclosed embodiments.

FIG. 2A illustrates a system of shareholder election, consistent with disclosed embodiments.

FIG. 2B illustrates an exemplary user device, consistent with disclosed embodiments.

FIG. 3 illustrates a flowchart of an exemplary process 300 for presenting an event associated with an asset to an owner of the asset.

FIG. 4 illustrates a flowchart of an exemplary process 400 for setting up a system for executing an event associated with an asset.

FIG. 5 illustrates a flowchart of an exemplary process 500 for presenting an election result in an event associated with an asset, respectively

FIGS. 6A-6D illustrate exemplary screens of a system that allows shareholders to make election in a tender offer, consistent with disclosed embodiments.

FIGS. 7A-7F illustrate exemplary screens of a system that allows a user to set up a system for executing a shareholder tender election, consistent with disclosed embodiments.

FIGS. 8A-8C illustrate exemplary screens of a system that presents the shareholder election result, consistent with disclosed embodiments.

FIG. 9 is an exemplary report document of shareholder election result, consistent with disclosed embodiments.

### DETAILED DESCRIPTION

Reference will now be made in detail to exemplary embodiments, discussed with reference to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added or removed without departing from the envisioned embodiments. Thus, the materials, methods, and examples are illustrative only and are not intended to be necessarily limited.

The present disclosure provides processes, including systems and methods, for executing events associated with an asset, which involves election of a multiplier of the asset by an owner of the asset. In some embodiments, the processes provided herein are used for shareholder election. In some embodiments, the processes described herein may provide greater flexibility in election settings, provide shareholders with a more streamlined user experience, and present the election status and results to the companies in a real-time and visualized manner. In some embodiments, the processes may involve three portals: a setup portal, a shareholder portal, and an outcome portal.

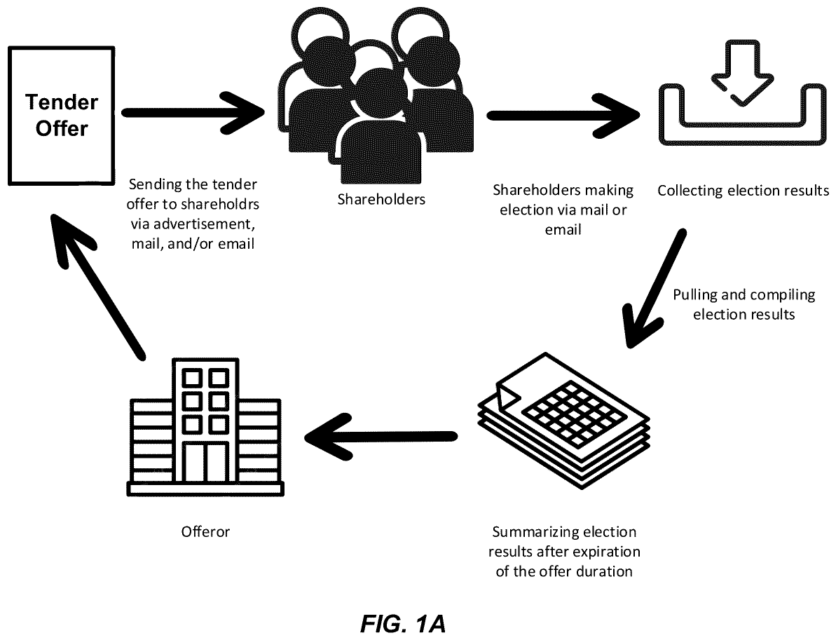

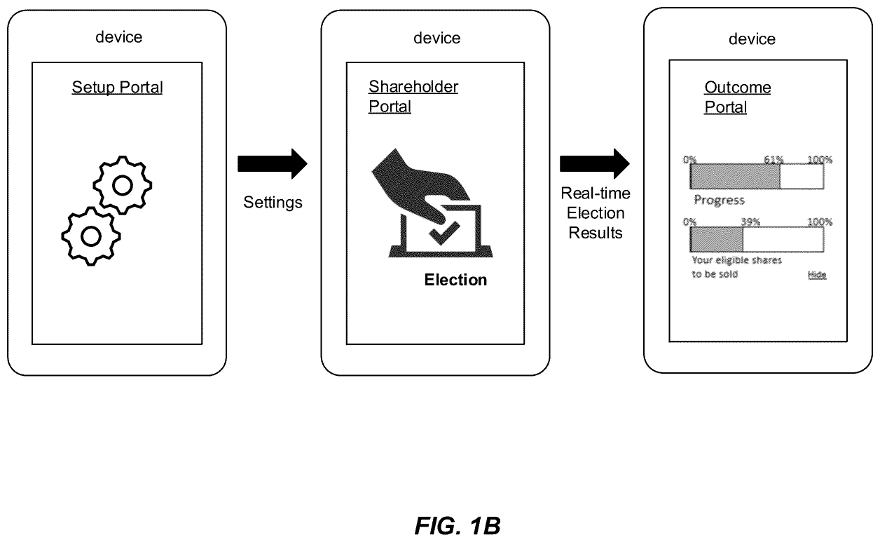

FIG. 1A is a schematic illustration of a traditional process of shareholder election in a tender offer, in which a tender offer is sent to shareholders via advertisement, mail, and/or email. Shareholders may decide whether to participate and make an election by mailing or emailing its election. The election results may be available after expiration of the offer. The company making the offer may view the election results by pulling and compiling the responses received from the shareholders.

FIG. 1B is a schematic illustration of the systems and portals for executing a shareholder election, consistent with disclosed embodiments. As shown in FIG. 1, a user (e.g., a bank employee) of a setup portal first configures the settings for an election event, which may include election settings, presentation settings, and confirmation settings. These settings may be stored in a memory and transmitted to a shareholder portal via a network. The shareholder portal may be configured according to these settings. A user of the shareholder portal (e.g., a shareholder) may make election in the shareholder portal. The result of shareholder election may be stored in a memory and transmitted to an outcome portal via a network in real time. A user of the outcome portal (e.g., a counsel in an M&A deal) may review the election outcome in the outcome portal in real time. These systems and portals significantly improve the traditional tender offer election process by offering greater flexibility in election settings, providing shareholders with a more streamlined user experience, and presenting real-time, visualized election status and results to companies.

### Systems, Processor, Memory, Network, and User Interface

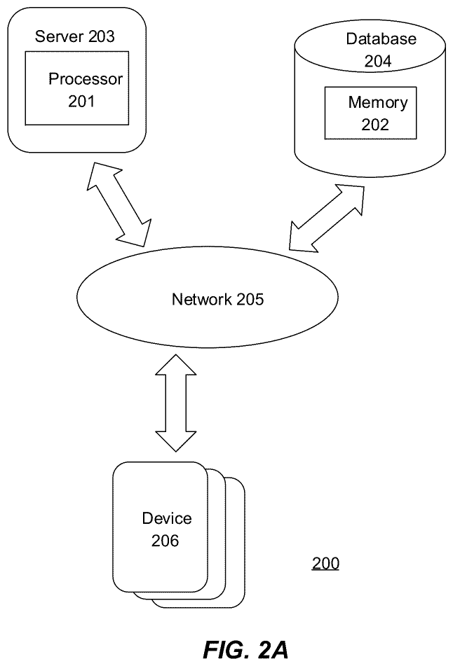

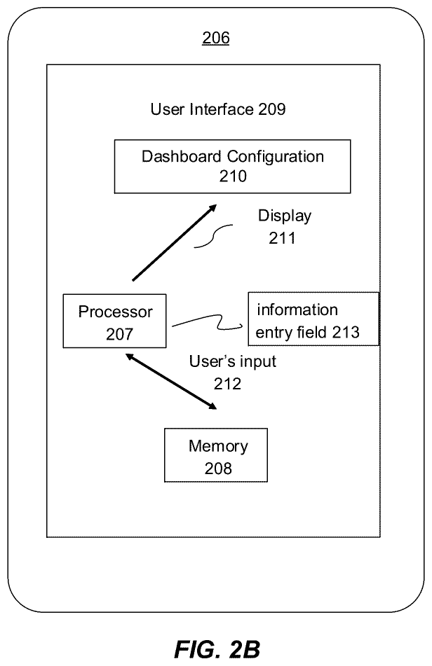

FIG. 2A illustrates an exemplary system 200 for shareholder tender election, consistent with disclosed embodiments. As shown in FIG. 2A, system 200 may include a server 203, which may include at least one processor 201. System 200 may also include a database 204, which may include at least one memory 202. System 200 may also include a network 205, and a user device 206. In system 200, server 203 and database 204 may communicate with each other via network 205. Server 203 and user device 206 may communicate with each other over network 205, and user device 206 and database 204 may communicate with each other over network 205.

A server, such as server 203 may be in communication with network 205. Server 203 may manage the various components in system 200. In some embodiments, server 203 may be configured to process and manage requests between user device 206 and database 204. Server 203 may participate in generating graphical elements on a graphical user interface to report shareholder election result, as disclosed herein.

The term “server” may refer to a computer or system that provides resources, data, services, or programs to other computers, known as clients, over a network. A server may be a web server, a mail server, or a virtual server.

Consistent with the present disclosure, disclosed embodiments may involve a network (e.g., 205). A network (e.g., 205) may constitute any type of physical or wireless computer networking arrangement used to exchange data between, for example, device 206, server 203, and/or database 202. For example, a network (e.g., 205) may be the Internet, a private data network, a virtual private network using a public network, a Wi-Fi network, a LAN or WAN network, a combination of one or more of the foregoing, and/or other suitable connections that may enable information exchange among various components of the system (e.g., 200). In some embodiments, a network (e.g., 205) may include one or more physical links used to exchange data, such as Ethernet, coaxial cables, twisted pair cables, fiber optics, or any other suitable physical medium for exchanging data. A network (e.g., 205) may also include a public switched telephone network (“PSTN”) and/or a wireless cellular network. A network (e.g., 205) may be a secured network or unsecured network. In other embodiments, one or more components of the system (e.g., 200) may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between for example, device 206, server 203, and/or database 204.

FIG. 2B illustrates an exemplary user device 206, consistent with disclosed embodiments. As shown in FIG. 2B, user device 206 may include at least one processor, such as processor 207. User device 206 may also include memory 208, and processor 207 may be connected to memory 208. User device 206 may also include user interface 209, and processor 207 may be connected to user interface 209. User interface 209 may also contain a dashboard configuration 210, and an information entry field 213 for receiving a user's input 212. Processor 207 may communicate display 211 to user interface 209 for displaying dashboard configuration 210. Processor 207 is different from processor 201 in that processor 207 is a part of device 206, while processor 201 operates independently of device 206. Memory 208 is different from memory 202 in that memory 208 is a part of device 206, while memory 202 operates independently of device 206.

Consistent with disclosed embodiments, “at least one processor” discussed herein and illustrated in the figures (e.g., 201 or 207) may constitute any physical device or group of devices having electric circuitry that performs a logic operation on an input or inputs. For example, the at least one processor 201 and/or 207 may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. In some embodiments, the at least one processor (e.g., 201 or 207) may include more than one processor. Each processor (e.g., 201 or 207) may have a similar construction or the processors (e.g., 201 or 207) may be of differing constructions that are electrically connected or disconnected from each other. For example, the processors (e.g., 201 or 207) may be separate circuits or integrated in a single circuit. When more than one processor (e.g., 201 or 207) is used, the processors (e.g., 201 or 207) may be configured to operate independently or collaboratively, and may be co-located or located remotely from each other. The processors (e.g., 201 or 207) may be coupled electrically, magnetically, optically, acoustically, mechanically or by other means that permit them to interact.

The instructions executed by at least one processor (e.g., 201 or 207) may, for example, be pre-loaded into a memory (e.g., 202 or 208), integrated with or embedded into the controller or may be stored in a separate memory. Memory (e.g., 202 or 208) may include a Random Access Memory (RAM), a Read-Only Memory (ROM), a hard disk, an optical disk, a magnetic medium, a flash memory, other permanent, fixed, or volatile memory, or any other mechanism capable of storing instructions. As used herein, a memory (e.g., 202 or 208), refers to any type of physical memory on which information or data readable by at least one processor may be stored. Examples of memory include Random Access Memory (RAM), Read-Only Memory (ROM), volatile memory, nonvolatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same.

The terms “memory” (e.g., 202 or 208) and “computer-readable storage medium” may refer to multiple structures, such as a plurality of memories or computer-readable storage mediums located within an input unit or at a remote location. Additionally, one or more computer-readable storage mediums may be utilized in implementing a computer-implemented method. The memory (e.g., 202 or 208) may include one or more separate storage devices collocated or disbursed, capable of storing data structures, instructions, or any other data. The memory (e.g., 202 or 208) may further include a memory portion containing instructions for the processor to execute. The memory (e.g., 202 or 208) may also be used as a working scratch pad for the processors (e.g., 201 or 207) or as a temporary storage. Accordingly, the term computer-readable storage medium should be understood to include tangible items and exclude carrier waves and transient signals.

Some embodiments may involve displaying information on a graphical user interface (e.g., 209), shown in FIG. 2B. A user interface (e.g., 209) may be part of a device (e.g., 206) that has inputs and outputs. Accordingly, a device (e.g., 206) may be a device that has the functionality necessary to realize a user interface 209. In some embodiments, a device (e.g., 206) may be a computing device, such as a mobile device, desktop, laptop, tablet, or any other devices capable of displaying, receiving, and processing data. Such a device (e.g., 206) may also include a display such as an LED display, augmented reality (AR), or virtual reality (VR) display.

User interface 209 may contain a dashboard configuration 210. Processor 207 may communicate display 211 to user interface 209 for displaying dashboard configuration 210. A dashboard configuration 210 may be displayed on any kind of display screen. For example, a dashboard configuration may be rendered on a mobile phone screen, a laptop computer screen, or a desktop computer screen. Display 211 may include the data that is displayed in the dashboard configuration 210. For example, display 211 may include a list of inquiries about an event associated with an asset.

A “dashboard configuration” may refer to a customizable layout, settings, and options displayed on a user interface that allow users to interact with, manage, or monitor specific data and functionalities of the system.

User interface 209 may further contain an information entry fields 213 for receiving a user's input 212. Information entry fields 213 may provide different means for a user using the user interface 209 to enter information that is eventually received by a processor (e.g., 201 and/or 207). By way of example, the information entry fields 213 may include a link, a button element, a drop-down menu, or an empty field for the user, or entity, to type in. A user's input 212 may be any information the user using user interface 209 wants to enter. In some embodiments, this user's input may include a user's indication to view the election result of a chosen asset, which may involve making a selection, from, for example, a drop-down menu in information entry field 213.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system (e.g., 200, a component of memory 202 or 208) or a remote computing component (e.g., a cloud-based data structure). Data in the data structure may be stored in contiguous or non-contiguous memory. Moreover, a data structure, as used herein, does not require information to be co-located. It may be distributed across multiple servers (e.g., 203), for example, that may be owned or operated by the same or different entities. Thus, the term “data structure” as used herein in the singular is inclusive of plural data structures.

Certain embodiments disclosed herein may include a processor (e.g., 201 or 207) configured to perform methods that may include triggering an action in response to an input. A trigger may include an input of a data item that is recognized by at least one processor (e.g., 201 or 207) that brings about another action.

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor (e.g., 201 or 207). It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer readable medium containing instructions that when executed by at least one processor (e.g., 201 or 207), cause the at least one processor (e.g., 201 or 207) to perform a method. Non-transitory computer readable mediums may be any medium capable of storing data in any memory (e.g., 202 or 208) in a way that may be read by any device with a processor (e.g., 201 or 207) to carry out methods or any other instructions stored in the memory (e.g., 202 or 208). The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”) (e.g., 201 or 207), a memory (e.g., 202 or 208), and input/output interfaces (e.g., 209). The computer platform may also include an operating system and microinstruction code. The various processes and functions described in this disclosure may be either part of the microinstruction code or part of the application program, or any combination thereof, which may be executed by a CPU, whether or not such a computer or processor (e.g., 201 or 207) is explicitly shown. In addition, various other peripheral units may be connected to the computer platform such as an additional data storage unit and a printing unit. Furthermore, a non-transitory computer readable medium may be any computer readable medium except for a transitory propagating signal.

Processor 201 and/or 207 may run computer applications. Applications may be mobile computer programs configured to run on mobile phones or tablet computers. Applications may also be computer programs configured to run on laptop computers or desktop computers. Computer applications may be computer software packages designed to carry out specific tasks. Some applications may be front end applications that interact directly with a computer or mobile device user. Processor 207 included in device 206 may, for example, run front end applications. Back-end applications may be applications that support the front-end applications and interact with the front-end applications. A front-end application may call the back-end application to process data or to retrieve or access data. Processor 201 included in server 203 may, for example, run back-end applications.

Embodiments described herein may refer to methods that include various steps. Unless the order is characterized as necessary, the steps of methods described herein may be performed in any order possible to achieve the results of the method.

As used herein, the terms “first,” “second,” “third,” “fourth,” “fifth,” and “sixth” used in conjunction with “dashboard configuration” do not imply the order in which a dashboard configuration is displayed in a process. These terms are used solely to distinguish between different dashboard configurations. For example, a fifth dashboard configuration may be displayed prior to a second dashboard configuration in a process.

### Methods and Shareholder Portal

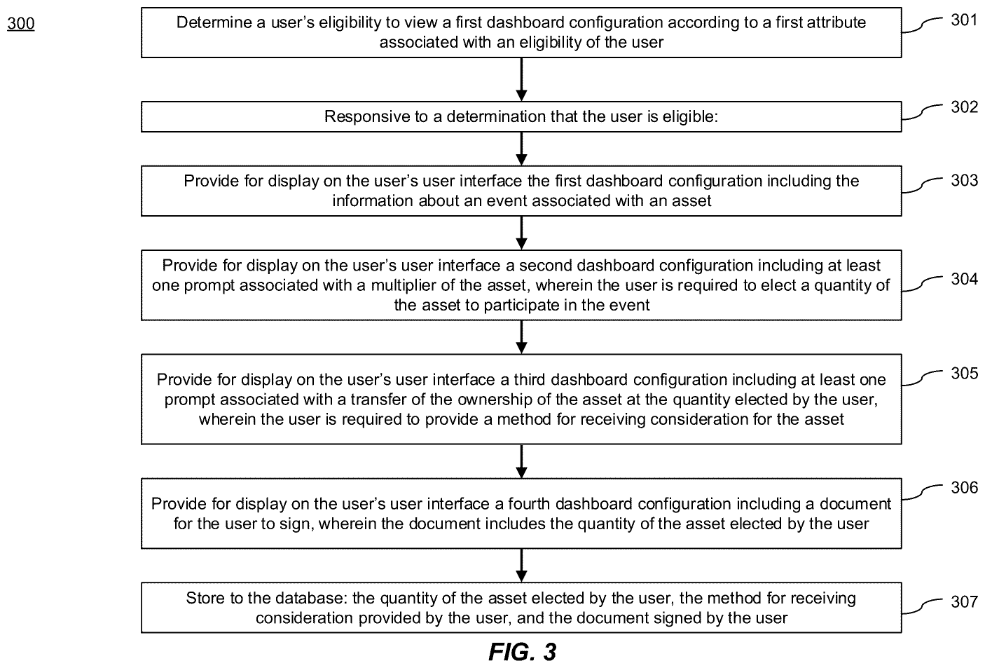

FIG. 3 illustrates a flowchart of an exemplary process 300 for presenting an event associated with an asset to an owner of the asset. In some embodiments, the event may be a shareholder election in response to a tender offer. In some embodiments, process 300 may enable a user to confirm its eligibility and willingness to participate in the event, review documents related to the event, make elections, and confirm elections. In some embodiments, the asset may be a security. In some embodiments, the security is an equity security. In some embodiments, the asset may one or more shares of a company.

Process 300 may include a step 301 of determining a user's eligibility to view a first dashboard configuration according to a first attribute associated with an eligibility of the user. The first dashboard configuration may include detailed information about the event, so it may be displayed only after the user is determined to be eligible. In some embodiments, the user may be a shareholder of a security. In some embodiments, the first attribute may be associated with the type and number of shares owned by a shareholder. In some embodiments, the first attribute may be associated with whether the shareholder is an accredited investor under 17 CFR § 230.501 (a). In some embodiments, the first attribute may be related to the user's credentials. In some embodiments, the user's credentials may include a username and a password. In some embodiments, the user's credential may include a user identification number. For example, a user's credentials may be checked against a database of authorized users to validate if the user is an authorized user. A processor, as described herein, may retrieve the first attribute associated with a user from a database over a network, consistent with disclosed embodiments. A processor may analyze the first attribute by comparing the first attribute with a predetermined standard to determine eligibility. For example, the processor may check if the user's credentials match the data in a database. For example, the processor may check if the type and number of shares owned by a shareholder match a standard required in a tender offer. In some embodiments, if any one of the attributes doesn't match the predetermined standard, the user may be determined to be ineligible.

In some embodiments, the user's eligibility to view information about the event may further be determined by the user's responses to certain questions, such as whether the user is an accredited investor, which may be included in a fifth dashboard configuration. In some embodiments, prior to determining the user's eligibility to view the first dashboard configuration, a processor may include providing for display on the user's user interface a fifth dashboard configuration including at least one inquiry associated with the eligibility and one or more selectable options for each inquiry, and storing a selection associated with the at least one inquiry in the database, wherein the user's eligibility to view the first dashboard configuration may be determined according to the first attribute and the user's selection to the at least one question. In some embodiments, the inquiry may be a prompt for a user to enter information. In some embodiments, the fifth dashboard configuration may prompt the user to enter their login credentials, such as a username and password. In some embodiments, the credentials are verified by the processor against a database of authorized users to determine if the user is authorized to access the system. In some embodiments, additional authentication methods may be used in process 300, such as biometric data or smart cards, to further validate the user's identity. In some embodiments, the inquiry may be a question with selectable options for a user to make a selection. In some embodiments, the inquiry may be related to a user's biographic information. In some embodiments, the inquiry may be related to verification of a user's biographic information. In some embodiments, the inquiry may be related to a user's name, address, account number and password, or an ownership of the asset. In some embodiments, the inquiry may be related to verification of number and type of shares of a security that a user owns. In some embodiments, the inquiry may be related to whether the user is an accredited investor under 17 CFR § 230.501 (a).

As used herein, the term “security” may refer to any financial instrument (or series of instruments) issued by a corporation, government, or other entity and that offers evidence of equity or debt. In some embodiments, the security may be a stock issued by a publicly traded company. In some embodiments, the security may be a stock issued by a private company. In some embodiments, the security may be a bond, a fund, an option, a future, a derivative, or a foreign exchange. As used herein, the term “inquiry” may refer to a question with selectable options or a prompt to enter information or make a selection.

Process 300 may include a step 302 of continuing the process responsive to a determination that the user is eligible.

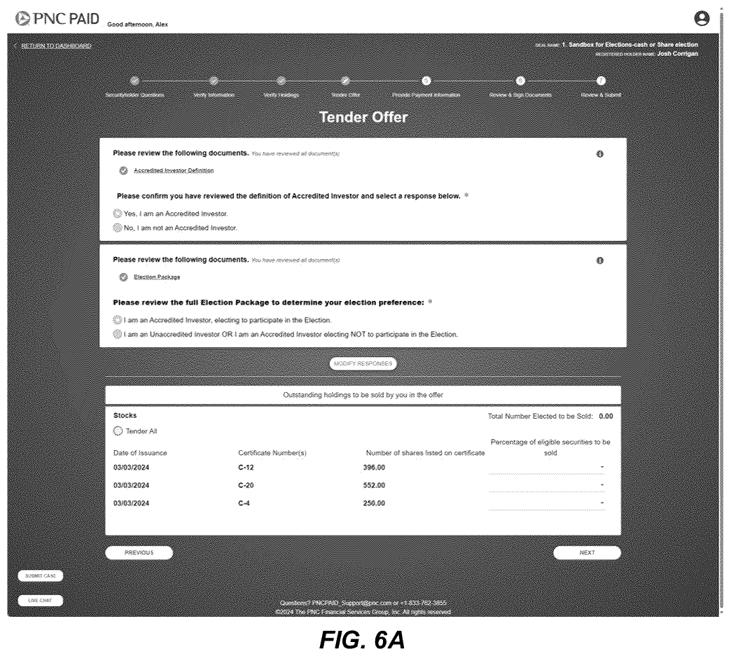

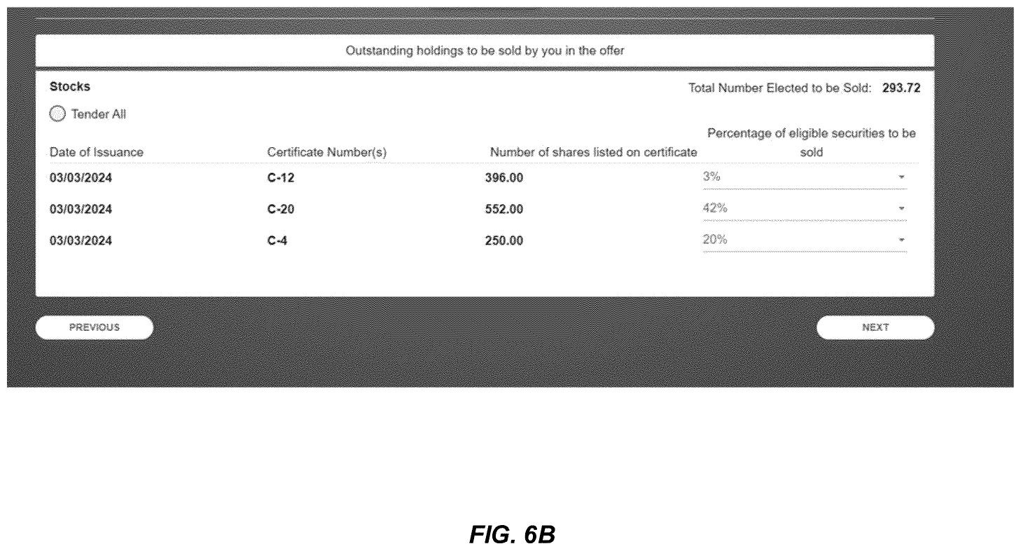

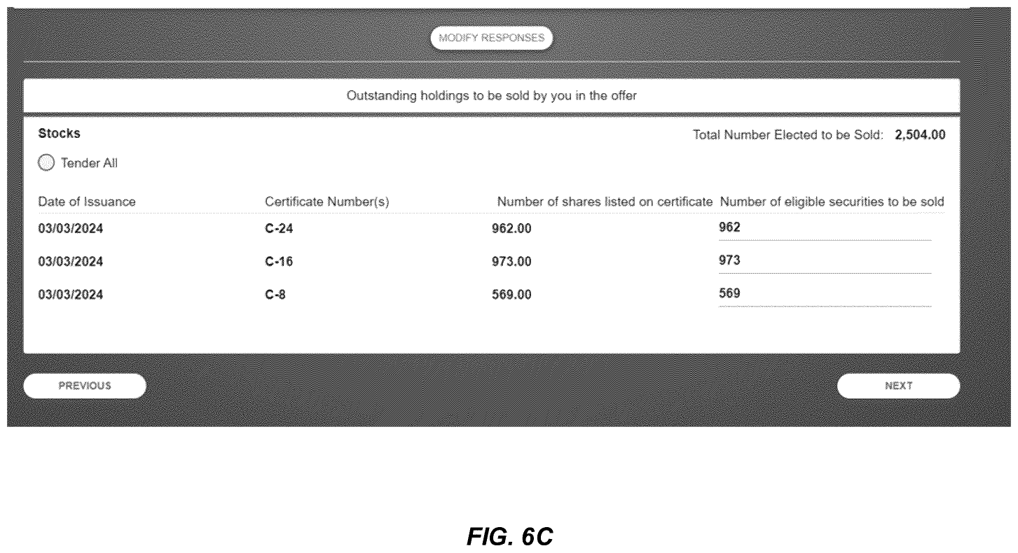

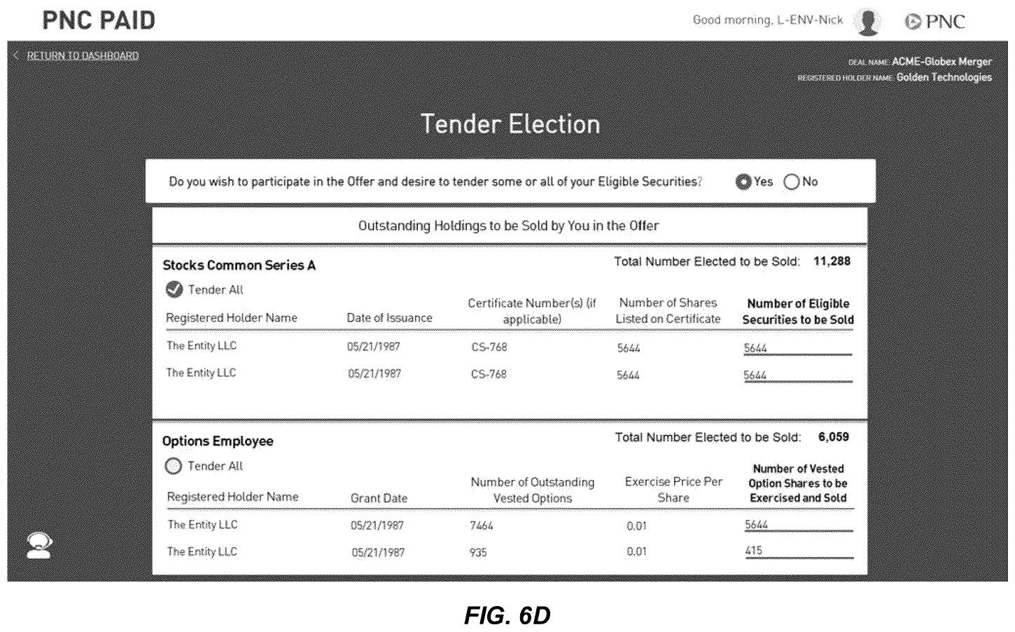

Process 300 may include a step 303 of providing for display on the user's user interface the first dashboard configuration including the information about an event associated with an asset, responsive to a determination that the user is eligible. In some embodiments, the first dashboard configuration may be presented upon the user's request to proceed from another dashboard configuration to the first dashboard configuration. For example, the user may click a button (e.g., “NEXT”) on a previous dashboard configuration to request display of the first dashboard configuration. In some embodiments, the user may request display of the first dashboard configuration only after completing all required fields in a previous dashboard configuration. In some embodiments, the first dashboard configuration may be presented automatically once the user has completed all required fields in a previous dashboard configuration. In some embodiments, the user may return to a previous dashboard configuration by requesting display of the previous dashboard configuration, such as by clicking a button (e.g. “PREVIOUS”) on the first dashboard configuration. In some embodiments, the user interface may include a navigation bar, allowing the user to access each dashboard configuration by clicking the corresponding button on the navigation bar. An exemplary navigation bar is shown at the top of FIG. 6A. In some embodiments, the navigation bar may include links to different dashboard configurations and/or icons representing each dashboard configurations. In some embodiments, when the first dashboard configuration is displayed, the previous configuration may stop displaying. Alternatively, in some embodiments, the previous dashboard configuration may be displayed simultaneously with the first dashboard configuration on the same page.

A processor may retrieve the information from a database over a network and display the information in the first dashboard configuration on the user's device, consistent with disclosed embodiments. In some embodiments, a user may access any of the dashboard configurations described herein through an online portal. The online portal may be a web-based UI (e.g., a web page or mobile application). In some embodiments, a user may access the dashboard configuration through a mobile application. In some embodiments, the event may be a shareholder election in response to a tender offer. A tender offer (“offer”) may be a bid to purchase some or all the shareholders' stock in a corporation. The party that makes the tender offer may be referred to as “the bidder.” Tender offers invite shareholders to sell their shares for a specified price and within a particular window of time. The offer may be made directly to the shareholders of the target company, bypassing the management and board of directors. The purpose of a tender offer is usually to gain control of the target company or to acquire a significant stake in it. Tender offers can be friendly or hostile, depending on whether the target company's management supports or opposes the offer. In a shareholder election, shareholders have the option to accept or reject the offer and elect the number of shares to sell in a tender offer. In some embodiments, the information about the event may include price per share, conditions or terms attached to the tender offer, start date and expiration date of the tender offer, procedures for tendering shares, maximum or minimum number of shares to be tendered, purpose and background of the tender offer, and any supporting documents. In some embodiments, the information is presented in one or more documents accessible via a link in the first dashboard configuration.

Process 300 may include a step 304 of providing for display on the user's user interface a second dashboard configuration including at least one prompt associated with a multiplier of the asset, wherein the user is required to elect a quantity of the asset to participate in the event. The second dashboard configuration may be where the user makes an election. In some embodiments, the second dashboard configuration may be displayed for the user to make an election after the user has reviewed the information about the event in the first dashboard configuration. In some embodiments, the second dashboard configuration may be displayed only after the user is determined to be eligible, reviews the information of the event in the first dashboard configuration, and confirms participation in the sixth dashboard configuration.

As used herein, a “multiplier of an asset” may refer to a specific quantity of an asset, such as a certain number of shares of a stock or options.

In some embodiments, the second dashboard configuration may be presented upon the user's request to proceed from another dashboard configuration to the second dashboard configuration. For example, the user may click a button (e.g., “NEXT”) on a previous dashboard configuration to request display of the second dashboard configuration. In some embodiments, the user may request display of the second dashboard configuration only after completing all required fields in a previous dashboard configuration, such as the first dashboard configuration. In some embodiments, the user may return to a previous dashboard configuration by requesting display of the previous dashboard configuration, such as by clicking a button (e.g. “PREVIOUS”) on the second dashboard configuration. In some embodiments, when the second dashboard configuration is displayed, the previous dashboard configuration may stop displaying. Alternatively, in some embodiments, the previous dashboard configuration may be displayed simultaneously with the second dashboard configuration on the same page. In some embodiments, the second dashboard configuration may be presented automatically once the user has completed all required fields in a previous dashboard configuration, such as the first dashboard configuration.

A processor may transmit the prompt to the user device via a network and receive a response from the user device over a network, consistent with disclosed embodiments. In some embodiments, the received response may be stored in a memory, consistent with disclosed embodiments. While this example discusses one user device, it is to be understood that this is merely exemplary, and multiple users may use the systems and methods disclosed herein. In some embodiments, the second dashboard configuration prompts the user to elect a quantity of the shares to be sold in a tender offer. In some embodiments, the second dashboard configuration shows a total number of shares owned by the user. In some embodiments, the second dashboard configuration may prompt the user to elect a quantity of shares from each certificate of shares (or stock certificate). In some embodiments, the second dashboard configuration may show a total number of elected shares. In some embodiments, the total number of elected shares may be calculated by adding up the elected quantity of shares from each certificate of shares (or stock certificate). In some embodiments, the quantity is in the form of a number, such as an integer. In some embodiments, the quantity may be in the form of a percentage of shares that the user owns. In some embodiments, the quantity may be subject to a predetermined upper limit. In some embodiments, the total number of elected shares may be subject to a predetermined upper limit. In some embodiments, the predetermined upper limit is set up by an employee, an agent, or a delegate of the company making the tender offer. In some embodiments, the predetermined upper limit may be stored in a memory and transmitted to the user's device via a network, consistent with disclosed embodiments.

In some embodiments, the second dashboard configuration may allow the user to make an election. In some embodiments, the second dashboard configuration may be displayed only if the user confirms participation in the event in a sixth dashboard configuration. In some embodiments, the user may be required to confirm participation after reviewing the information of the event in the first dashboard configuration. In some embodiments, prior to providing for display the second dashboard configuration, process 300 may include providing for display on the user's user interface a sixth dashboard configuration including at least one inquiry associated with event participation, and one or more selectable options for each inquiry, storing a selection associated with the at least one inquiry in the database, wherein the second dashboard configuration may be displayed on the user's user interface only if the user selects to participate in the event. For example, the inquiry may be a question of whether the user decides to participate the event, and the selectable options are “Yes, I elect to participate in the event” and “No, I elect not to participate in the event.” In some embodiments, the inquiry may be a prompt. In some embodiments, the inquiry may be a question with selectable options. In some embodiments, the question and the selectable options are about whether the user wants to participate in the election. In some embodiments, the second dashboard configuration is not displayed if the user selects not to participate in the election.

In some embodiments, the sixth dashboard configuration may be presented upon the user's request to proceed from another dashboard configuration to the sixth dashboard configuration. For example, the user may click a button (e.g., “NEXT”) on a previous dashboard configuration, such as the first or the fifth dashboard configurations, described herein, to request display of the sixth dashboard configuration. In some embodiments, the user may request display of the sixth dashboard configuration only after completing all required fields in a previous dashboard configuration, such as the first or the fifth dashboard configuration, described herein. In some embodiments, the sixth dashboard configuration may be presented automatically once the user has completed all required fields in a previous dashboard configuration, such as any of the first or the fifth dashboard configuration, described herein. In some embodiments, the user may return to a previous dashboard configuration by requesting display of the previous dashboard configuration, such as by clicking a button (e.g. “PREVIOUS”) on the sixth dashboard configuration. In some embodiments, when the sixth dashboard configuration is displayed, the previous configuration may stop displaying. Alternatively, in some embodiments, the previous dashboard configuration may be displayed simultaneously with the sixth dashboard configuration on the same page.

In some embodiments, after making an election in the second dashboard configuration, the user may be required to provide payment method information in a third dashboard configuration. Process 300 may include a step 305 of providing for display on the user's user interface a third dashboard configuration including at least one prompt associated with a transfer of the ownership of the asset at the quantity elected by the user, wherein the user may be required to provide a method for receiving consideration for the asset. In some embodiments, the third dashboard configuration may be presented upon the user's request to proceed from another dashboard configuration to the third dashboard configuration. For example, the user may click a button (e.g., “NEXT”) on a previous dashboard configuration to request display of the third dashboard configuration. In some embodiments, the user may request display of the third dashboard configuration only after completing all required fields in a previous dashboard configuration. In some embodiments, the third dashboard configuration may be presented automatically once the user has completed all required fields in a previous dashboard configuration. In some embodiments, the user may return to a previous dashboard configuration by requesting display of the previous dashboard configuration, such as by clicking a button (e.g. “PREVIOUS”) on the third dashboard configuration. In some embodiments, when the third dashboard configuration is displayed, the previous configuration may stop displaying. Alternatively, in some embodiments, the previous dashboard configuration may be displayed simultaneously with the third dashboard configuration on the same page.

A processor may transmit the prompt to the users' device via a network, and receive the responses from the user's device via network and store this data set in a memory. In some embodiments, the third dashboard configuration may prompt the user to provide a payment method. In some embodiments, the payment method may include a form of payment, for example, in cash, in stock, or a combination of both. In some embodiments, the payment method may include bank account details, such as account number, routing number, and relevant SWIFT code for international payments. In some embodiments, the payment method may include brokerage account details. In some embodiments, the payment method may include tax information. In some embodiments, a processor may verify the payment method provided by the user. For example, the processor may check for format errors, perform an authorization check by confirming with the financial institution that the payment method is active and has sufficient funds or credit available, and/or perform a small, temporary charge or hold on the account, which the client can verify to confirm ownership.

In some embodiments, the user may be required to sign and submit a document in a fourth dashboard configuration after making the election in the second dashboard configuration and providing the payment method in the third dashboard configuration. Process 300 may include a step 306 of providing for display on the user's user interface a fourth dashboard configuration including a document for the user to sign, wherein the document includes the quantity of the asset elected by the user. In some embodiments, the fourth dashboard configuration may be presented upon the user's request to proceed from another dashboard configuration to the fourth dashboard configuration. For example, the user may click a button (e.g., “NEXT”) on a previous dashboard configuration to request display of the fourth dashboard configuration. In some embodiments, the user may request display of the fourth dashboard configuration only after completing all required fields in a previous dashboard configuration. In some embodiments, the fourth dashboard configuration may be presented automatically once the user has completed all required fields in a previous dashboard configuration. In some embodiments, the user may return to a previous dashboard configuration by requesting display of the previous dashboard configuration, such as by clicking a button (e.g. “PREVIOUS”) on the fourth dashboard configuration. In some embodiments, when the fourth dashboard configuration is displayed, the previous configuration may stop displaying. Alternatively, in some embodiments, the previous dashboard configuration may be displayed simultaneously with the fourth dashboard configuration on the same page.

A processor may retrieve the user's input from a memory via a network, create a document using this retrieved data, and display it on the user's device. In some embodiments, the processor may create the document based on a template, wherein the template is stored in a database, consistent with disclosed embodiments. In some embodiments, the processor may first retrieve the template from a database, which may include standard legal language, clauses, and placeholder fields for variable elements such as names, dates, terms, and conditions. The processor may then retrieve the user's input from a database and map the user's input to corresponding placeholders within the template. If the template includes conditional clauses, the processor may then apply rules to include or exclude certain sections based on user's input. In some embodiments, the document may be a contract. In some embodiments, the document includes the information about the event. In some embodiments, the document may be customized for each user by applying the user's election to the template. In some embodiments, the document may be customized for each user by incorporating the payment method provided by the user in step 105. In some embodiments, the user signs the document via an E-signature service. This service allows the user to sign the document electronically, eliminating the need for physical signatures and paper documents. The use of an E-signature service also ensures that the document is securely stored and easily accessible for future reference. In some embodiments, the transaction of shares may be carried out in accordance with the terms specified in the signed document.

Process 300 may include a step 307 of storing to a database: the quantity of the asset elected by the user, the method for receiving consideration provided by the user, and the document signed by the user. A processor may receive the data set from the user's device via a network and store this data set in a memory in a database. In some embodiments, process 300 may be used to collect shareholder's election result and related information, such as information related to accredited investor and payment method. In some embodiments, the data collected in process 300 may be retrieved and displayed in a process identical or similar to process 500.

In some embodiments, process 300 may performed before a predetermined date. In some embodiments, the predetermined date may an expiration date of the tender offer. In some embodiments, none of the dashboard configurations are displayed after the predetermined date. In some embodiments, not displaying the dashboard configurations may be because the due date for making an election has passed. In some embodiments, only dashboard configurations that are directly involved in shareholder's election are not displayed after the predetermined date. For example, in some embodiments, only the second, third, and fourth dashboard configuration are not displayed after the predetermined date.

Information described above may be stored in a database as a group of data elements, which may be stored in a manner such that the data elements may be organized and associated with each other. For example, these data elements may include shareholder names, identifiers, number of shares held, types of shares held, date of transaction. For any given entity, these data elements may be associated with each other in memory, consistent with disclosed embodiments. The data elements associated with each shareholder may be complied into an overall data set stored in a memory. The data elements that may make up the data set may be associated using any means for associating data. Some examples of associating data may include using a linked list, a look up table, or by storing the first entity information in the same database record, or by using other similar methods. A linked list may consist of nodes stored in a memory. A node may include a basic unit in a data structure, such as a linked list, and each node may contain a data field and a reference to the next node in the list. A “linked list” may refer to a data structure where each element, or “node”, contains data and a link to the next element in the sequence. Linked lists may be used to organize data within tables. A look up table may be an array of data in a memory that may map input values to output values. Given a set of input values, a processor may query a look up table to retrieve the corresponding output values from the table. For example, the input value may be a shareholder's name, and the output value is this shareholder's election. As another example, a database record may be a collection of information organized in a table that pertains to a specific topic or category. In retrieving information from the database, a processor may access data in a memory via a network.

### Methods and Setup Portal

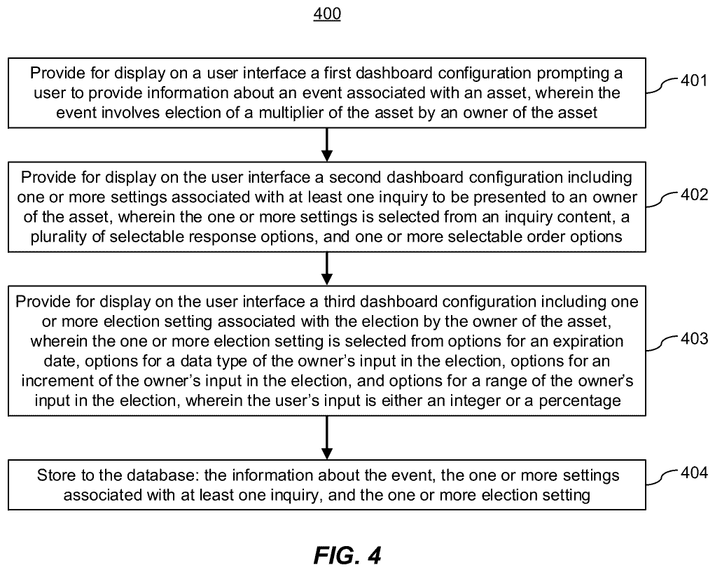

FIG. 4 illustrates a flowchart of an exemplary process 400 for setting up a system for executing an event associated with an asset. In some embodiments, the event may be a shareholder election in response to a tender offer. In some embodiments, process 400 may enable a user to customize the settings of the event and the way the event is presented to an owner of the asset.

Process 400 may include a step 401 of providing for display on a user interface a first dashboard configuration prompting a user to provide information about an event associated with an asset, wherein the event involves election of a multiplier of the asset by an owner of the asset. A processor may receive the data set from the user's device via a network and store this data set in a memory in a database. In some embodiments, the user may be an employee, an agent, or a delegate of the company making the tender offer. In some embodiments, the information about the event may include price per share in a tender offer, conditions or terms attached to the tender offer, start date and expiration date of the tender offer, procedures for tendering shares, maximum or minimum number of shares to be tendered, purpose and background of the tender offer, and any supporting documents.

Process 400 may include a step 402 of providing for display on the user interface a second dashboard configuration including one or more settings associated with at least one inquiry to be presented to an owner of the asset, wherein the one or more settings may be selected from an inquiry content, a plurality of selectable response options, and one or more selectable order options.

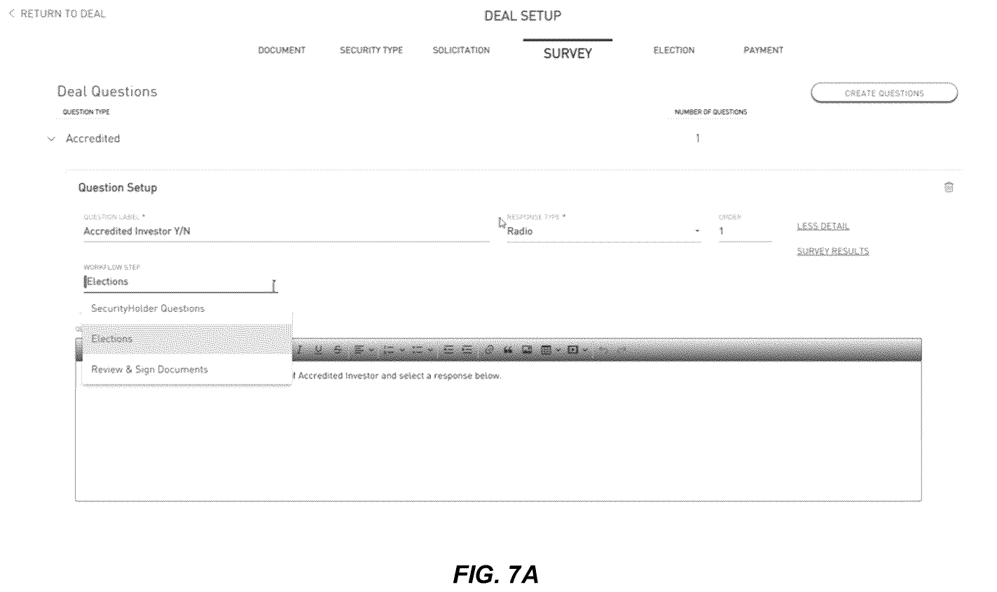

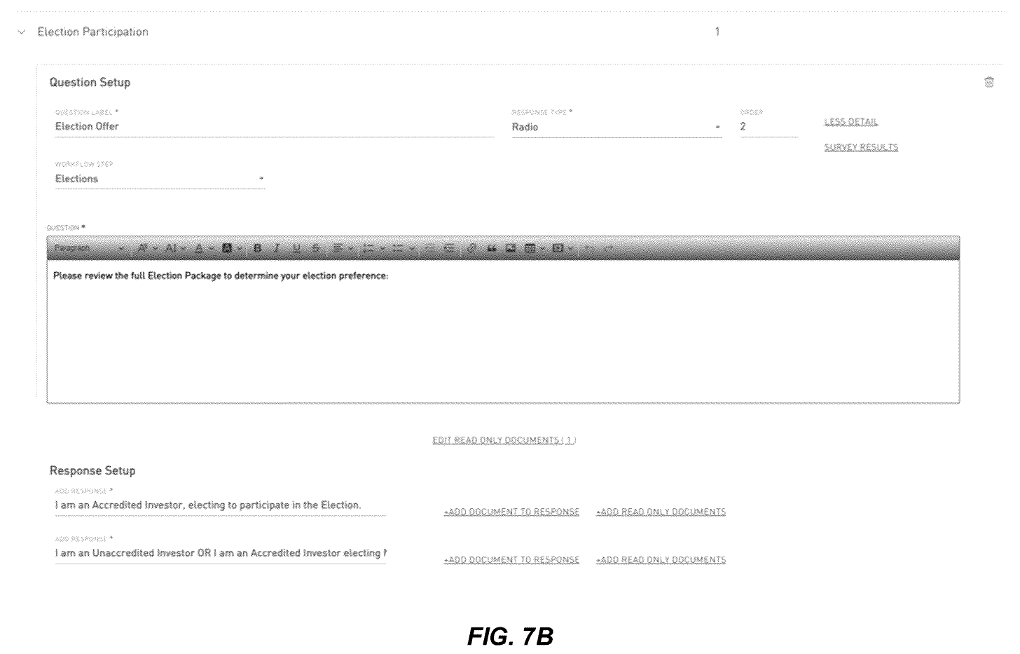

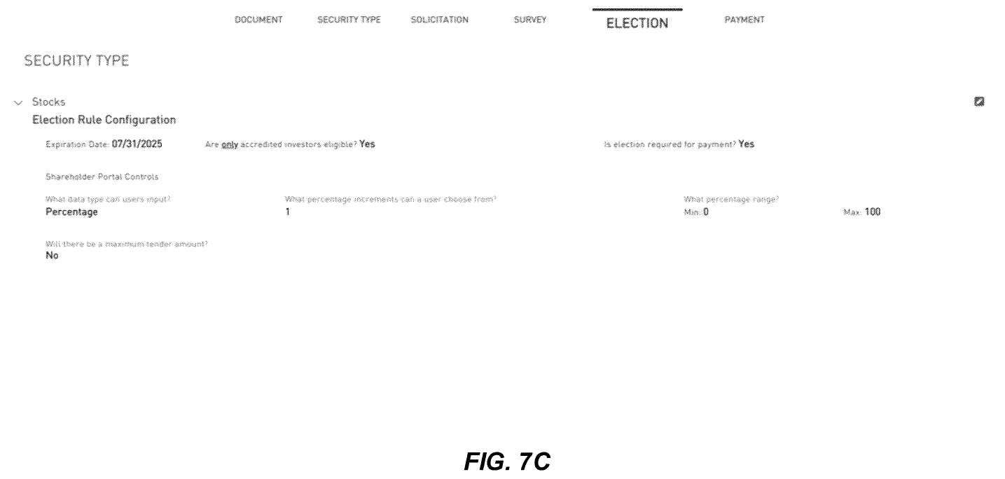

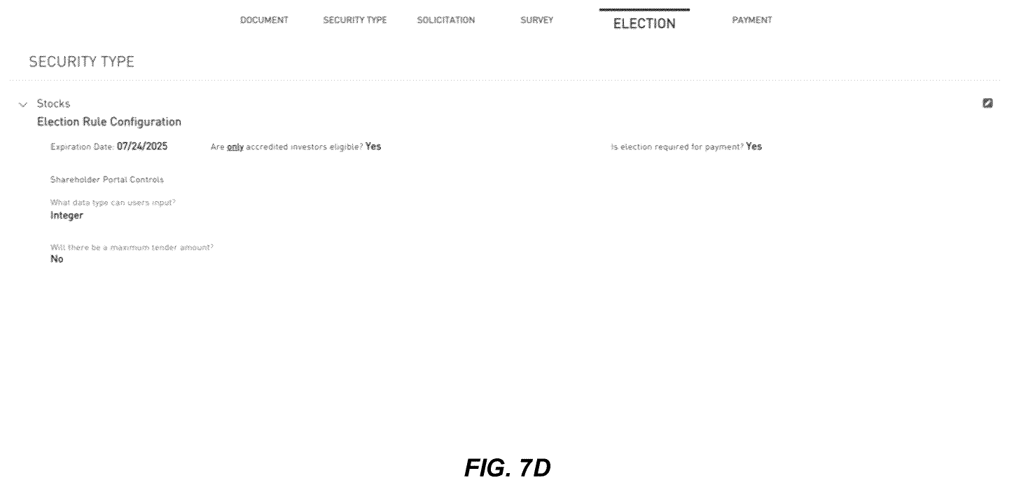

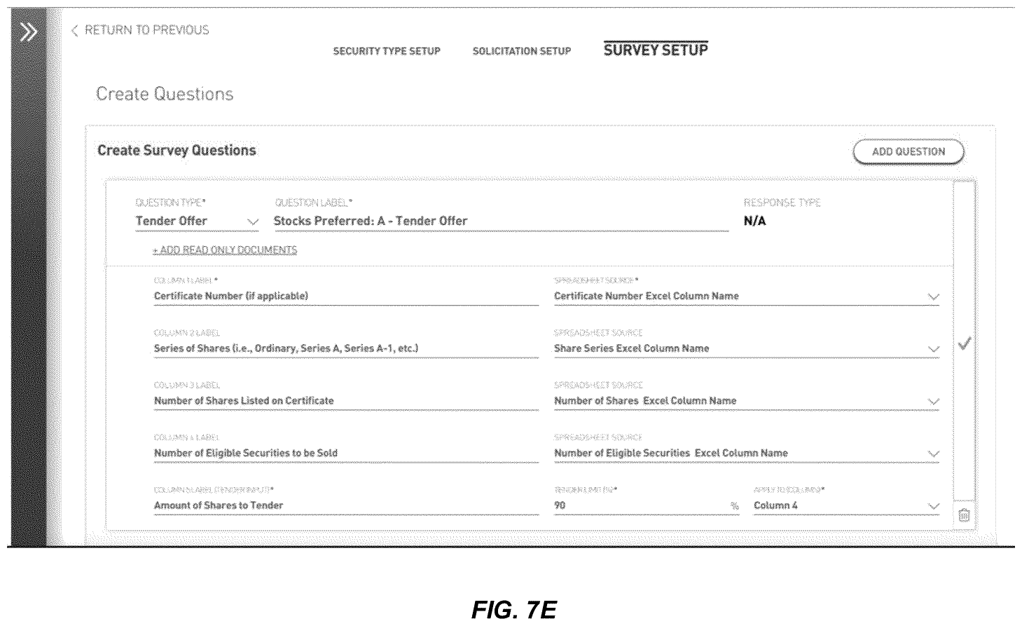

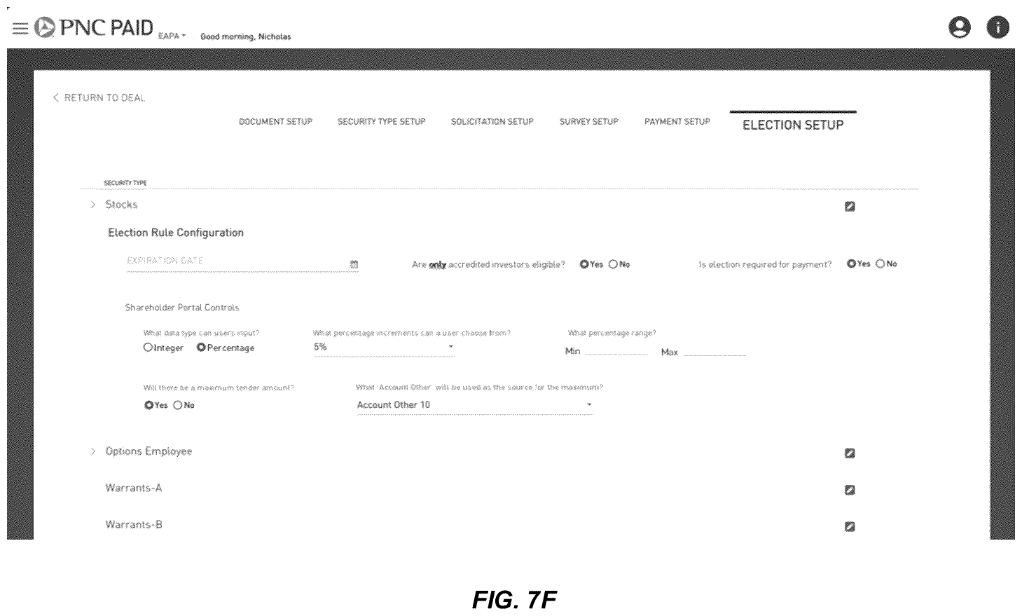

In some embodiments, the second dashboard configuration may be presented upon the user's request to proceed from another dashboard configuration to the second dashboard configuration. For example, the user may click a button (e.g., “NEXT”) on a previous dashboard configuration, such as the first dashboard configuration, to request display of the second dashboard configuration. In some embodiments, the user may request display of the second dashboard configuration only after completing all required fields in a previous dashboard configuration. In some embodiments, the second dashboard configuration may be presented automatically once the user has completed all required fields in a previous dashboard configuration. In some embodiments, the user may return to a previous dashboard configuration by requesting display of the previous dashboard configuration, such as by clicking a button (e.g. “PREVIOUS”) on the second dashboard configuration. In some embodiments, when the second dashboard configuration is displayed, the previous configuration may stop displaying. Alternatively, in some embodiments, the previous dashboard configuration may be displayed simultaneously with the second dashboard configuration on the same page. In some embodiments, the user interface may include a navigation bar, allowing the user to access each dashboard configuration by clicking the corresponding button on the navigation bar. An exemplary navigation bar is shown at the top of FIG. 7A. In some embodiments, the navigation bar may include links to different dashboard configurations and/or icons representing each dashboard configurations.

A processor may receive the data set from the user's device via a network 405 and store this data set in a memory in a database. In some embodiments, the inquiry may be a question with selectable options. In some embodiments, wherein the inquiry is a question, the user may input the question content and configure selectable options for the question in an information entry field in the second dashboard configuration. For example, the question may be related to election participation, and the selectable options may be “I am electing to participate in the Election” and “I am electing not to participate in the Election.” (see FIG. 7B). In some embodiments, the user can set the number of options that may be selected for a given question, for example, by entering an integer ranger from 1-3, 1-4, 1-5, or 1-6 in an information entry field in the second dashboard configuration. In some embodiments, the inquiry may be a prompt. In some embodiments, the user may input the prompt content in an information entry field in the second dashboard configuration, and configure the response format, such as text, number, or percentage, for example, by selecting from a drop list in the second dashboard configuration. In some embodiments, the inquiry may be related to information of an owner of the asset, including the owner's name, address, credentials, account number and password, number and type of shares owned. In some embodiments, the inquiry may be related to whether an owner of the asset is an accredited investor. In some embodiments, the user may configure an order for all the inquires in the second dashboard configuration. For example, the user may select an order of display for an inquiry. For example, the user may select “Question No. 1” for a question related to accredited investor, and “Question No. 2” for an inquiry related to election participation.

In some embodiments, the one or more settings further includes selectable actions to be triggered by each selectable option for the at least one inquiry. For instance, specific selections may trigger different workflows or display additional information in process 400, enhancing the interactive and dynamic aspects of the election process. In some embodiments, a second inquiry may be presented conditionally, depending on the response to a preceding inquiry. For example, a question regarding whether a shareholder intends to participate in an election may appear only when the shareholder selects “yes” in response to a question about accredited investor status. This conditional inquiry system allows for tailored user interactions, ensuring that shareholders encounter only relevant prompts and reducing unnecessary steps.

The settings may include more complex decision trees. In some embodiments, the user may set up rules that trigger multiple conditional inquiries to appear based on combinations of selected responses to earlier inquiries. For example, only if a shareholder verifies its holding and confirms accredited investor status, the dashboard configuration to make election is presented. In some embodiments, the user may define specific rules or criteria for displaying follow-up inquiries. This may include setting thresholds or conditions for inquiry presentation, such as only presenting certain inquiries if prior responses meet specific eligibility criteria, thereby supporting nuanced decision-making and enhancing overall usability. For example, as shown in FIG. 7F, a user may select YES for “Are only accredited investors eligible?” in an election rule configuration dashboard.

Process 400 may include a step 403 of providing for display on the user interface a third dashboard configuration including one or more election setting associated with the election by the owner of the asset, wherein the one or more election setting is selected from options for an expiration date, options for a data type of the owner's input in the election, options for an increment of the owner's input in the election, or options for a range of the owner's input in the election, wherein the user's input is either an integer or a percentage. In some embodiments, the third dashboard configuration may be presented upon the user's request to proceed from another dashboard configuration to the third dashboard configuration. For example, the user may click a button (e.g., “NEXT”) on a previous dashboard configuration, such as the second dashboard configuration, to request display of the third dashboard configuration. In some embodiments, the user may request display of the third dashboard configuration only after completing all required fields in a previous dashboard configuration. In some embodiments, the third dashboard configuration may be presented automatically once the user has completed all required fields in a previous dashboard configuration. In some embodiments, the user may return to a previous dashboard configuration by requesting display of the previous dashboard configuration, such as by clicking a button (e.g. “PREVIOUS”) on the third dashboard configuration. In some embodiments, when the third dashboard configuration is displayed, the previous configuration may stop displaying. Alternatively, in some embodiments, the previous dashboard configuration may be displayed simultaneously with the third dashboard configuration on the same page. A processor may receive the data set from the user's device via a network and store this data set in a memory in a database.

As used herein, “data type” of user's input may refer to the format and constraints of the input, such as whether it should be a text string, integer, decimal, date, binary choice (e.g., yes/no), percentage, or other predefined format.

In some embodiments, the user may set an expiration date for the event. In some embodiments, a shareholder may not make an election after the expiration date. In some embodiments, the user may update or adjust the expiration date based on changing conditions. In some embodiments, the user may designate the input format as numerical, text-based, or binary. In some embodiments, the input format for making an election may be an integer. In some embodiments, the input format for making an election may be a percentage. In some embodiments, the user may set an increment of the owner's input in the election. For example, when the input format is integer, the increment may be 1, 10, 100, or a specific quantity. For example, when the input format is percentage, the increment may be 0.1%, 0.5%, 1%, or a specific percent. This setting provides the user granular control over their election input. In some embodiments, the options for a range of input values enable the user to set minimum or maximum thresholds for shareholder's input. This can prevent unintentional over-subscription of shares and ensure all election inputs remain within predefined boundaries. As used herein, “over-subscription” may refer to (1) a situation in which the number of shares elected by a shareholder to sell exceeds the number of shares owned by the shareholder, or (2) a situation in which the total number shares elected by the shareholders to sell in a tender offer exceeds the maximum total number of shares required in the tender offer.

In some embodiments, the process may further include providing for display on the user interface a fourth dashboard configuration including one or more confirmation setting associated with a confirmation of a transfer of asset at the multiplier elected by the user, wherein the one or more confirmation setting is selected from a content of at least one inquiry about an owner's preferred method for receiving consideration for the asset, and a content of a document associated with the election to be signed by the owner; and storing the one or more confirmation setting to a database. In some embodiments, the method for receiving consideration for the asset may be a method for receiving payment (payment method). In some embodiments, the “confirmation setting” is a distinct group of settings, separate from “election settings” and “presentation settings,” and may include settings related to the user's confirmation of election and payment method.

In some embodiments, the fourth dashboard configuration may be presented upon the user's request to proceed from another dashboard configuration to the fourth dashboard configuration. For example, the user may click a button (e.g., “NEXT”) on a previous dashboard configuration, such as the third dashboard configuration, to request display of the fourth dashboard configuration. In some embodiments, the user may request display of the fourth dashboard configuration only after completing all required fields in a previous dashboard configuration. In some embodiments, the fourth dashboard configuration may be presented automatically once the user has completed all required fields in a previous dashboard configuration. In some embodiments, the user may return to a previous dashboard configuration by requesting display of the previous dashboard configuration, such as by clicking a button (e.g. “PREVIOUS”) on the fourth dashboard configuration. In some embodiments, when the fourth dashboard configuration is displayed, the previous configuration may stop displaying. Alternatively, in some embodiments, the previous dashboard configuration may be displayed simultaneously with the fourth dashboard configuration on the same page. In some embodiments, the preferred method may be a payment method. In some embodiments, the payment method may include bank account details, such as account number, routing number, and relevant SWIFT code for international payments. In some embodiments, the payment method may include a form of payment, for example, in cash, in stock, or a combination of both. In some embodiments, the payment method may include brokerage account details. In some embodiments, the payment method may include tax information. In some embodiments, the user can input a template for the document associated with the election, intended for the owner's signature. This template may include standard clauses, customizable fields, and election-specific content, allowing it to be tailored to various election requirements and legal standards. In some embodiments, the document may be a contract. In some embodiments, the contract includes terms of the election, such as agreements on asset transfer, consideration details, and obligations of both the shareholder and the issuer. This contract could include options for different contractual terms, enabling the user to configure it according to specific corporate or regulatory requirements. In some embodiments, the user can set up E-signature service for the document. E-signature service provides a secure and convenient method for the owner to complete and authenticate the agreement electronically. The e-signature service may include multi-factor authentication, timestamps, and audit trails to ensure compliance with electronic signature standards and maintain the integrity of the signed document.

In some embodiments, process 400 may further include providing for display, on the user interface, a fifth dashboard configuration including one or more presentation setting associated with a presentation of the event to the owner, wherein the one or more presentation setting includes selectable options for an order of each of the at least one question, the election, and the confirmation of a transfer. In some embodiments, the fifth dashboard configuration may be presented upon the user's request to proceed from another dashboard configuration to the fifth dashboard configuration. For example, the user may click a button (e.g., “NEXT”) on a previous dashboard configuration, such as the fourth dashboard configuration, to request display of the fifth dashboard configuration. In some embodiments, the user may request display of the fifth dashboard configuration only after completing all required fields in a previous dashboard configuration. In some embodiments, the fifth dashboard configuration may be presented automatically once the user has completed all required fields in a previous dashboard configuration. In some embodiments, the user may return to a previous dashboard configuration by requesting display of the previous dashboard configuration, such as by clicking a button (e.g. “PREVIOUS”) on the fifth dashboard configuration. In some embodiments, when the fifth dashboard configuration is displayed, the previous configuration may stop displaying. Alternatively, in some embodiments, the previous dashboard configuration may be displayed simultaneously with the fifth dashboard configuration on the same page. In some embodiments, the user can customize the sequence of inquiries and election based on priority or logical flow. For instance, inquiries requiring preliminary input could be displayed first, followed by election options, and concluding with confirmation settings. In other embodiments, the user may set up rules for certain sections or questions to appear based on prior responses or election choices made by the owner. This dynamic presentation allows for a more intuitive and responsive interface, minimizing unnecessary steps and presenting only relevant information to a shareholder. Further embodiments may allow for adjustable layouts and visual elements within the dashboard, enabling the user to modify the arrangement, font size, or color schemes of the display.

Process 400 may include a step 404 of storing to a database: (1) the information about the event, (2) the one or more settings associated with at least one inquiry, (3) the one or more election setting, and all other settings.

Information described above may be stored in a database as a group of data elements, which are stored in a manner that the data elements may be organized and associated with each other. For any given entity, these data elements may be associated with each other in a memory. The data elements associated with each shareholder may be complied into an overall data set stored in a memory. The data elements that may make up the data set may be associated using any means for associating data. Some examples of associating data may include using a linked list, a look up table, or by storing the first entity information in the same database record, or by using other similar methods. A linked list may consist of nodes stored in a memory. A node may comprise a basic unit in a data structure, such as a linked list, and each node may contain a data field and a reference to the next node in the list. A look up table may be an array of data in a memory that may map input values to output values. Given a set of input values, the at least one processor may query a look up table to retrieve the corresponding output values from the table. As another example, a database record may be a collection of information organized in a table that pertains to a specific topic or category. In retrieving information from the database, a processor may access data in a memory over a network.

### Methods and Outcome Portal

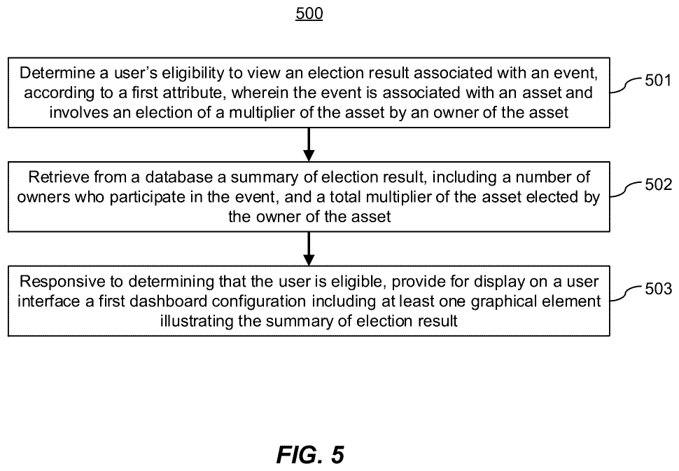

FIG. 5 illustrates a flowchart of an exemplary process 500 for presenting an election result in an event associated with an asset. In some embodiments, the event may be a shareholder election in response to a tender offer. In some embodiments, process 500 presents the real-time election result in a visualized way. In some embodiments, process 500 visualizes the progression and results of a shareholder tender election to the user.

Process 500 may include a step 501 of determining a user's eligibility to view an election result associated with an event, according to a first attribute, wherein the event is associated with an asset and involves an election of a multiplier of the asset by an owner of the asset. A processor may retrieve the first attribute from a database via a network. A processor may analyze the first attribute by comparing with a predetermined standard to determine eligibility.

Process 500 may include a step 502 of retrieving from a database a summary of election result, including a number of owners who participate in the event, and a total multiplier of the asset elected by the owner of the asset. In some embodiments, the summary of election result, including a number of owners who participate in the event, and a total multiplier of the asset elected by the owner of the asset, may be obtained through a process identical or similar to process 300. A processor may retrieve the summary of election result from a database via network.

Process 500 may include a step 503 of providing for display on a user interface a first dashboard configuration including at least one graphical element illustrating the summary of election result, responsive to determining that the user is eligible. A user may learn the current progression and results of a shareholder tender election directly from the at least one graphical element displayed in the graphical user interface. In some embodiments, a user may access the dashboard configuration through an online portal. The online portal may be a web-based UI (e.g., a web page or mobile application). In some embodiments, a user may access the dashboard configuration through a mobile application. In some embodiments, only an authorized user may access the graphical user interface having the at least one graphical element. In some embodiments, an authorized user may be an employee, an agent, or a delegate of the company making the tender offer or involved in the merger or acquisition deal. In some embodiments, a user may be required to input specific credentials, which a processor then verifies against an authorized user database to determine whether the user has authorized access. In some embodiments, the dashboard configuration may include a graphical user interface configured to allow the user to toggle on or off the display of the at least one graphical element illustrating any of the percentages calculated by the at least one processor. For example, the dashboard configuration may include an icon on the graphical user interface, which can be activated by a mouse, pointer, finger, or voice command, among other options to toggle on or off the display of a graphical element.

In some embodiments, process 500 may further include retrieving from the database a total number of owners of the asset and displaying in the first dashboard configuration a graphical element illustrating a first percentage of the owners who participate in the event over the total number of owners of the asset. In some embodiments, a processor may generate the first percentage by retrieving the number of shareholders who submit election and dividing it by the total number of shareholders of a security.

In some embodiments, process 500 may further include retrieving from the database a total multiplier of the asset owned by all the owners, and displaying in the first dashboard configuration, a graphical element illustrating a second percentage of the total multiplier of the asset elected by all the owners over the total multiplier of the asset owned by all the owners. In some embodiments, this graphical element illustrating the second percentage may visualize the proportion of shares of a security that are elected for sale in a tender offer. In another embodiments, a processor retrieves the number of shares that a shareholder elected to sell in a tender offer and divides it by the number of total shares held by the same shareholder to generate a percentage indicating the proportion of the shareholder's shares elected for sale in a tender offer.

In some embodiments, process 500 may further include retrieving from the database the maximum total multiplier of the asset that can be elected by the at least one owner of the asset, and displaying in the first dashboard configuration a graphical element illustrating a third percentage of the total multiplier of the asset elected by the at least one owner of the asset over the maximum total multiplier of the asset that can be elected by the at least one owner of the asset. This percentage may be used to indicate the progression of the shareholder tender election. In some embodiments, the processor retrieves the total number of shares elected by the shareholders in a tender election and divides it by the total number of shares requested in the offer, or divides it by the maximum total number of shares that can be elected by the at least one owner of the asset. In some embodiments, this percentage may be displayed by a progress bar.

In some embodiments, process 500 may further include retrieving from the database the minimum total multiplier of the asset to be elected by the at least one owner of the asset in order for the tender offer to be valid. In some embodiments, the tender offer may be conditioned on shareholders tendering a minimum number of shares. If the minimum number of shares is not tendered by the expiration date, the offer may be closed. For a conditioned tender offer, the number of shares requested in the offer is the minimum number of shares that the offer is conditioned on.

In some embodiments, process 500 may be repeated at a predetermined time interval. In some embodiments, process 500 may be repeated upon user's request. In some embodiments, the predetermined time interval may be 0.5, 1, 2, 3, 4, 5, 6, 7, 8, 9, 10, 15, 20, 30, 40, 50, or 60 seconds. A user may request repeating process 300 by submitting a request for refreshing the webpage. A processor may repeatedly access data in a memory to retrieve the most current voting result and update the graphical element on the graphical user interface accordingly by transmitting updated data sets and display to the user's device.

In some embodiments, the first dashboard configuration in process 500 may be configured to allow the user to turn on or off the at least one graphical element. In some embodiments, the at least one graphical element displayed in the first dashboard configuration may be a progress bar, a pie chart, or a table. As used herein, a graphical element may refer to any visual representation of information on a graphical user interface. This visual representation may be essential for users to understand the data and information being presented. The graphical element may help users quickly and easily identify trends, patterns, and anomalies in the data. The type of graphical element can vary depending on the nature of the data being presented. The graphical element may be a progress bar, a bar graph, a line graph, a pie chart, a gauge chart, or a table. In some embodiments, the graphical element may illustrate more than one percentage calculated by the at least one processor. For example, a progress bar may be used to illustrate the progress of a project, e.g., a tender election. A bar graph may be used to compare different sets of data. A line graph may be used to show trends over time. A pie chart may be used to illustrate the proportion of different categories. A gauge chart may be used to show how close a value is to a target value. A table may be used to present detailed information in a structured format. The graphical element may be either static or interactive. The graphical element may also serve as an electronic hyperlink or file shortcut to access data. A user may activate a graphical element using, for example, a mouse, pointer, finger, or voice command, among other options. A graphical element's placement on the graphical user interface may provide further information about the usage or associations with relevant data. In some embodiments, the graphical element may include data other than at least one of the percentages calculated by the at least one processor. For example, the graphical element may display additional information such as the date range of the data being presented, the currency in which the data is being displayed, or any other relevant information that may assist the user in understanding the data being presented. This additional information can help the user to better interpret the data and make more informed decisions.

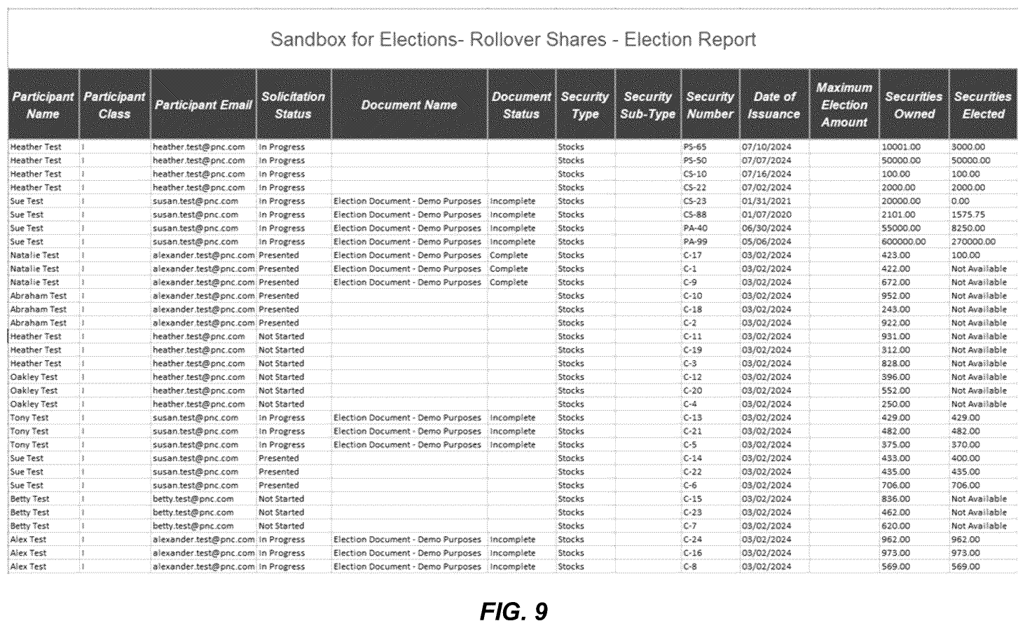

In some embodiments, the first dashboard configuration may include a report document including the summary of election result. In some embodiments, the process 500 may further include retrieving an election result for each of the owner of the asset, and wherein the first dashboard configuration further includes a report document including the election result for each of the owner of the asset. A processor may retrieve relevant data from a memory and generate a report document with the retrieved data. A processor may store the report document in a memory. The dashboard may include an electronic hyperlink or file shortcut to access the report document. A user may access the report document by activating the hyperlink or file shortcut. In some embodiments, the report document comprises of a list of shareholders who elect to sell at least one share in the shareholder tender election, and the number and type of share each shareholder elects to sell. In some embodiments, the report document may be an Excel file, a Word file, or a PDF file. In some embodiments, the report document may include one or more of the following entries: account number, name 1, name 2, address 1, address 2, city, state/province, foreign country name, postal code, tax id, account type, legend, shares, issue date, book entry, cost basis covered indicator, cbr price per share, cbr price available, cbr acquisition method, cbr acquisition ndate, cbr ton, participant id, email address, participant type, status, and status_last_updated_ts. In some embodiments, the report document may comprise one ore more of the following entries: Participant Name, Participant Class, Participant Email, Solicitation Status, Document Name, Document Status, Security Type, Security Sub-Type, Security Number, Date of Issuance, Maximum Election Amount, Securities Owned, Securities Elected. FIG. 9 is an exemplary report document.

### EXAMPLES

FIGS. 6A-6D illustrates exemplary screens of a shareholder portal. FIG. 6A presents an exemplary screen for a “Tender Offer” step including an inquiry and selectable options associated with accredited investor, and an inquiry and selectable options associated with the user's participation in the tender election. At the bottom of FIG. 6A, the screen presents an exemplary dashboard configuration for the user to make a tender election. FIG. 6A also shows that the shareholder portal may include 7 steps: Securityholder Questions, Verify Information, Verify Holdings, Tender Offer, Provide Payment Information, Review & Sign Documents, and Review &Submit. Depending on how survey questions were setup, a shareholder may answer none, one, or multiple surveys on this step. FIG. 6B is a closeup of the bottom portion of FIG. 6A, showing how the election of shares is inputted via percentages. FIG. 6C is a closeup of the bottom portion of FIG. 6A, showing how the election is inputted via integers. FIG. 6D is another exemplary screen of tender offer election step, including election of stocks and options. It shows election of common stocks and options via integer input.

FIGS. 7A-7F illustrate exemplary screens of a setup portal. FIG. 7A presents an exemplary screen for a “Survey” setup step including settings of deal questions, such as an accredited investor question. FIG. 7A also shows that the setup portal may include 6 steps for settings: Document, Security type, Solicitation, Survey, Election, and Payment. As shown in FIG. 7A, a user may designate an order for a survey question and move a survey question to different workflow steps in a shareholder portal. Question label “Accredited Investor Y/N” means that a shareholder will not be allowed to make an election if he is unaccredited (this label is to be used in conjunction with Accreditation requirement on the Election Setup page of the setup portal).

FIG. 7B illustrates an exemplary screen for setting up an election participation question. Election participation questions may be used to determine if election should be available to a user or not. If answered NO, the election may be hidden, if YES then the election may be shown. Similarly, if an accreditation question is applicable, the election may be hidden if answered NO, and the election may be shown if answered YES. An election participation question may also be shown on different steps. For example, in FIG. 7B, it is tied to the “elections” step, which is the most commonly use case. Regardless of which step the election question is shown on, the conditional logic described herein may always apply.

FIG. 7C illustrates an exemplary settings module for election functionality. The settings are grouped at a “Security Type” level, so that only the applicable bucket of shareholders are included in the event, for deals that have many different shareholders. The settings here show that only accredited investors are eligible for election. FIG. 7C also shows that the election may be done in percentages (e.g., a shareholder can elect 1%, 5%, 20%, of their holdings). The expiration date shows that the election functionality will be unavailable after Jul. 25, 2024.

FIG. 7D illustrates an exemplary settings module for election functionality. The settings are grouped at a “Security Type” level, so that only the applicable bucket of shareholders are included in the event, for deals that have many different shareholders. The settings here show that only accredited investors are eligible for election. FIG. 7D also shows that the election may be done by inputting an integer (e.g., a holder can elect 10, 20, or 100 shares of their holdings). The expiration date shows that the election functionality will be unavailable after Jul. 25, 2024.

FIG. 7E is another exemplary screen for setting up survey questions, which includes question label, and column labels and data source for each column in an election result report spreadsheet.

FIG. 7F is another exemplary screen for setting up election functionality. The exemplary screen enables set up of an expiration date for the election. The settings here show that only accredited investors are eligible for election, and election is required for payment. The settings also show that shareholder should input a percentage, at an increment of 5%, and subject to a maximum tender amount to make an election.

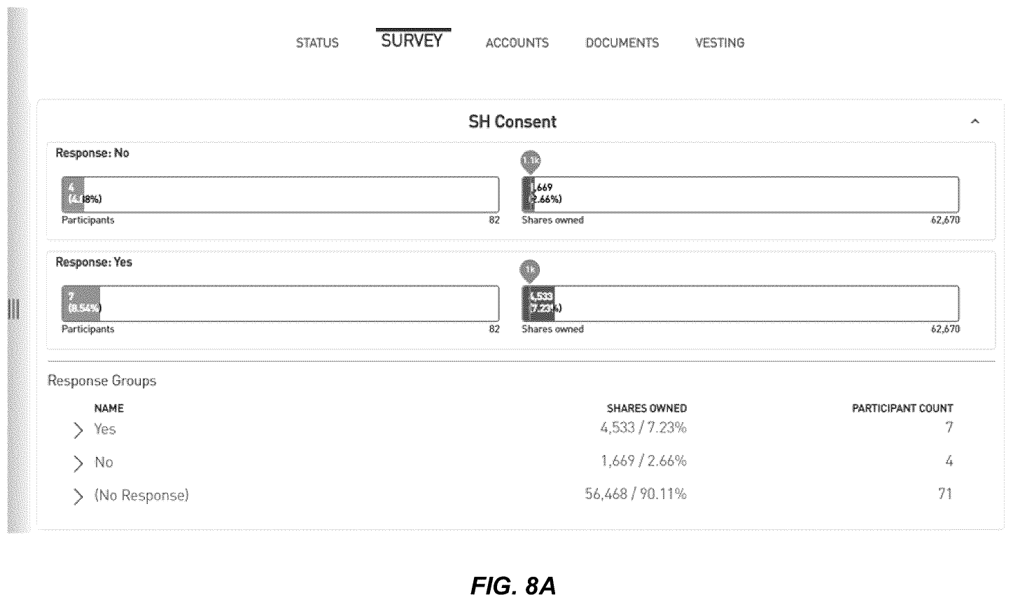

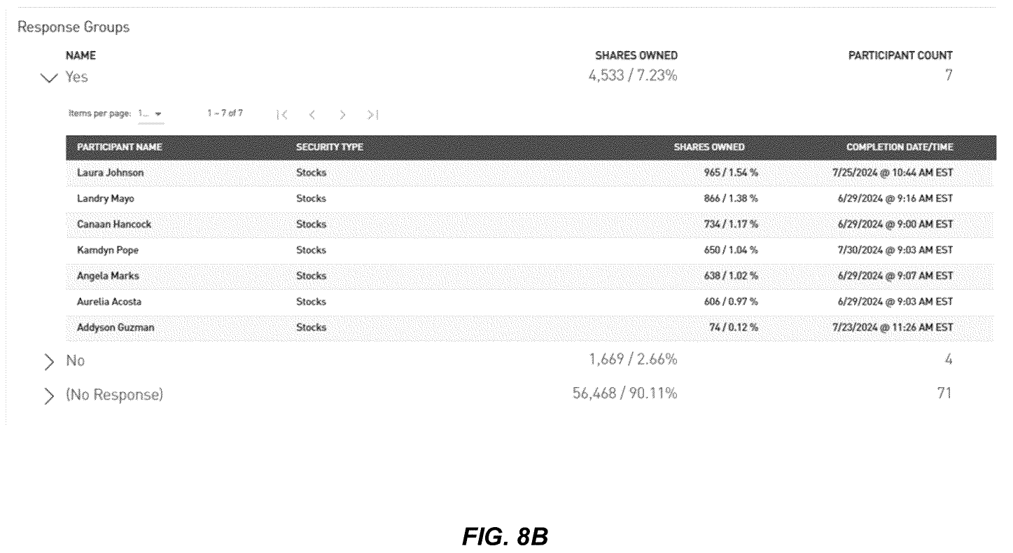

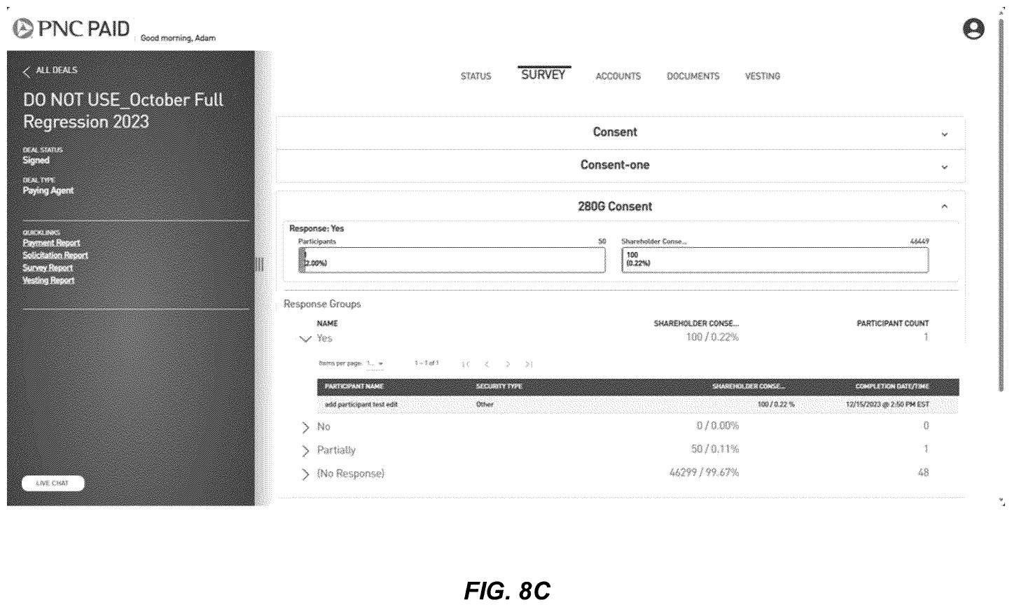

FIGS. 8A-8C illustrate exemplary screens of an outcome portal. FIG. 8A illustrates an exemplary screen showing how visualizations could be represented for election functionality. FIG. 8A shows light grey progress bars that indicate how many participants have answered a survey question such as one regarding shareholder consent on a particular issue. The underlying shares are also shown with the deep grey progress bars. FIG. 8B shows a table illustrating participating shareholders, share owned by each participating shareholder, and the date and time of their completion of the election. FIG. 8C is another exemplary screen showing visualization of survey question result. The bar graphs show the number and percentage of participants and shareholders who respond YES to a question. The section at the bottom lists the number of shareholders and participants who respond YES, NO, Partially, or No response, respectively.

FIG. 9 is an exemplary report document of a shareholder election result, consistent with disclosed embodiments. FIG. 9 illustrates a spreadsheet listing the following entries: participant name, participant class, participant email, solicitation status, document name, document status, security type, security sub-type, security number, date of issuance, maximum election amount, securities owned, and securities elected. “Participant class” may refer to a group or category of the participant according to a classification such as the number of shares held, the type of shares (e.g., common or preferred), the length of ownership, or other criteria outlined in corporate governance rules or shareholder agreements. “Solicitation status” may refer to the current progress of efforts to request shareholders to participate in an election. “Security type” may refer to a type of security owned by the participant, such as stocks or options. “Security sub-type” may refer to a sub-type of security owned by the participant, such as a common stock or preferred stock. “Security number” may refer to a certificate number of a security, such as a stock certificate number or a option certificate number. “Date of issuance” may refer to the date that the certificate was issued. “Maximum election amount” may refer to the maximum number of a security that a participant may elect in an election. “Securities owned” may refer to a number of shares of a security that is owned by a participant. “Securities elected” may refer to a number of shares of a security that is elected by a participant in the election.

1.-10. (canceled)

11. A system comprising:
a memory storing instructions; and
a processor configured to execute the instructions to perform operations to:
determine a user's eligibility to view an election result associated with an event based on a first attribute;
analyze the first attribute by comparing the first attribute with a predetermined standard to determine eligibility;
retrieve, from a database, a summary of the election result;
upon determining the user is eligible, provide for display on a user interface, a first dashboard configuration including at least one graphical element illustrating the summary of the election result;
submit a request to refresh the first dashboard configuration based on updated data; and
display, on the first dashboard configuration, results based on the updated data.

12. The system of claim 11, wherein the event is associated with an asset and involves an election of a multiplier of the asset by an owner of the asset.

13. The system of claim 12, wherein the summary of the election results includes a number of owners who participated in the event and a total multiplier of the asset.

14. The system of claim 13, wherein the at least one graphical element is further configured to illustrate the total multiplier of the asset.

15. The system of claim 11, wherein the at least one graphical element illustrates a current progression and a result of a shareholder tender election.

16. The system of claim 11, wherein the at least one graphical element further includes a toggle configured to turn the display of the first dashboard configuration on or off.

17. The system of claim 11, wherein the operations further include: retrieving, from the database, a minimum total multiplier of an asset to be elected by at least one owner of the asset for a tender offer to be valid, wherein the tender offer is conditioned on at least one shareholder tendering a minimum number of shares.

18. The system of claim 17, wherein if the minimum number of shares is not tendered by an expiration date, the tender offer is closed.

19. The system of claim 17, wherein the first dashboard configuration is further configured to display one or more selectable options regarding the tender offer.

20. The system of claim 11, wherein the operations are performed at a predetermined time interval.

21. The system of claim 11, wherein the operations further include retrieving a most current voting result and updating the at least one graphical element.

22. The system of claim 11, wherein the at least one graphical element is one of a progress bar, a pie chart, or a table.

23. The system of claim 11, wherein the first dashboard configuration further includes a report document.

24. The system of claim 23, wherein the first dashboard configuration includes a link to access the report document.

25. The system of claim 11, wherein the operations further include displaying a second dashboard configuration, the second dashboard configuration displaying an outcome portal.

26. The system of claim 25, wherein the second dashboard configuration is configured to use color to display results on the outcome portal.

27. The system of claim 25, wherein the second dashboard configuration is further configured to display a survey question result.

28. The system of claim 25, wherein the operations further include activating a graphical element associated with the second dashboard configuration.

29. A method comprising:
determining a user's eligibility to view an election result associated with an event based on a first attribute;
analyzing the first attribute by comparing the first attribute with a predetermined standard to determine eligibility;
retrieving, from a database, a summary of the election result;
upon determining the user is eligible, provide for display on a user interface, a first dashboard configuration including at least one graphical element illustrating the summary of the election result;
submitting a request to refresh the first dashboard configuration based on updated data; and
displaying, on the first dashboard configuration, results based on the updated data.
